(19) United States
(12) Patent Application Publication
(10) Pub. No.: US 2011/0264461 A1
(43) Pub. Date: Oct. 27, 2011

(54) Brains-server synapses-empowered networking

(76) Inventor: Anuthep Benja-Athon, New York, NY (US)

(21) Appl. No.: 13/134,139

(22) Filed: May 31, 2011

Related U.S. Application Data
(63) Continuation-in-part of application No. 13/065,518, filed on Mar. 24, 2011.
Application No. 13/065,518 is a continuation-in-part of application No. 12/924,054, filed on Sep. 20, 2010.
Application No. 12/924,054 is a continuation-in-part of application No. 12/804,588, filed on Jul. 26, 2010.
Application No. 12/804,588 is a continuation-in-part of application No. 12/799,207, filed on Apr. 21, 2010.
Application No. 12/799,207 is a continuation-in-part of application No. 12/658,112, filed on Feb. 3, 2010.
Application No. 12/658,112 is a continuation-in-part of application No. 12/655,748, filed on Jan. 7, 2010.
Application No. 12/655,748 is a continuation-in-part of application No. 12/592,714, filed on Dec. 2, 2009.
Application No. 12/592,714 is a continuation-in-part of application No. 12/381,654, filed on Mar. 16, 2009.
Application No. 12/381,654 is a continuation-in-part of application No. 12/322,529, filed on Feb. 4, 2009.
Application No. 12/322,529 is a continuation-in-part of application No. 12/321,141, filed on Jan. 16, 2009.
Application No. 12/321,141 is a continuation-in-part of application No. 12/080,433, filed on Apr. 3, 2008.
Application No. 12/080,433 is a continuation-in-part of application No. 12/069,409, filed on Feb. 11, 2008.
Application No. 12/069,409 is a continuation-in-part of application No. 11/986,657, filed on Nov. 26, 2007, now abandoned.
Application No. 11/986,657 is a continuation-in-part of application No. 11/803,621, filed on May 16, 2007.
Application No. 11/803,621 is a continuation-in-part of application No. 11/716,062, filed on Mar. 9, 2007, now abandoned.
Application No. 11/716,062 is a continuation-in-part of application No. 11/649,873, filed on Jan. 5, 2007, now abandoned.
Application No. 11/649,873 is a continuation-in-part of application No. 11/637,662, filed on Dec. 13, 2006, now abandoned.
Application No. 11/637,662 is a continuation-in-part of application No. 11/599,847, filed on Nov. 16, 2006, now abandoned.
Application No. 11/599,847 is a continuation-in-part of application No. 11/431,046, filed on May 10, 2006, now abandoned.
Application No. 11/431,046 is a continuation-in-part of application No. 11/543,895, filed on Oct. 6, 2006, now abandoned.
Application No. 11/543,895 is a continuation-in-part of application No. 11/523,945, filed on Sep. 21, 2006, now abandoned.
Application No. 11/523,945 is a continuation-in-part of application No. 11/510,820, filed on Aug. 28, 2006, now abandoned.
Application No. 11/510,820 is a continuation-in-part of application No. 11/477,121, filed on Jun. 29, 2006, now abandoned.
Application No. 11/477,121 is a continuation-in-part of application No. 11/114,763, filed on Apr. 27, 2005, now abandoned.
Application No. 11/114,763 is a continuation-in-part of application No. 11/196,823, filed on Aug. 4, 2005, now abandoned.
Application No. 11/196,823 is a continuation-in-part of application No. 11/973,866, filed on Oct. 11, 2007, now abandoned.
Application No. 11/973,866 is a continuation-in-part of application No. 11/293,689, filed on Dec. 5, 2005, now abandoned.
Application No. 11/293,689 is a continuation-in-part of application No. 11/150,878, filed on Jun. 13, 2005, now abandoned.
Application No. 11/150,878 is a continuation-in-part of application No. 11/074,236, filed on Mar. 7, 2005, now abandoned.
Application No. 11/074,236 is a continuation-in-part of application No. 11/022,410, filed on Dec. 27, 2004, now abandoned.
Application No. 11/022,410 is a continuation-in-part of application No. 09/191,795, filed on Nov. 13, 1998, now Pat. No. 6,132,218.

(51) Int. Cl. G06Q 50/00

(52) U.S. Cl. 705/2

(57) ABSTRACT

The networks of people, computer servers, teleconferencing platforms and communication devices for precisely guiding and assisting in expeditiously diagnosing and managing and treating diseases and illnesses for, by, among and between said people using said networks.

This application is a continuation-in-part of 13/065,518 entitled Brains-empowered networking filed Mar. 24, 2011, a continuation-in-part of Ser. No. 12/924,054 entitled A server-guidance of health-care I filed Sep. 20, 2010, a continuation-in-part of Ser. No. 12/804,588 entitled An intelligent computer-biological electronic-neural health-care system filed Jul. 26, 2010, a continuation-in-part of Ser. No. 12/799,207 entitled Computer-created-consensus-based health-care system filed Apr. 21, 2010, a continuation-in-part of Ser. No. 12/658,112 entitled A system and method for computer-generations of diagnoses filed Feb. 3, 2010, a continuation-in-part of Ser. No. 12/655,748 entitled the Artificial-intelligent system and method for managing health-care filed Jan. 7, 2010, a continuation-in-part of Ser. No. 12/592,714 entitled the Healthcare Exchange IV filed Dec. 2, 2009, a continuation-in-part of Ser. No. 12/381,654 filed Mar. 16, 2009 entitled the Adaptable compositions of health information, a continuation-in-part of Ser. No. 12/322,529 entitled the Healthcare Exchange II filed Feb. 4, 2009, a continuation-in-part of Ser. No. 12/321,141 entitled the Best system of health and health-care data management filed Jan. 16, 2009, a continuation-in-part of Ser. No. 12/080,433 entitled The Healthcare Exchange filed Apr. 3, 2008, a continuation-in-part of Ser. No. 12/069,409 entitled the Filing of Health and Health-care data filed Feb. 11, 2008, continuation-in-part of Ser. No. 11/986,657 entitled A hierarchy of medical word headers filed Nov. 26, 2007, a continuation-in-part of Ser. No. 11/803,621 entitled Patients' and physicians' data management filed May 16, 2007, a continuation-in-part of Ser. No. 11/716,062 entitled A sieve of words in health-care data filed Mar. 9, 2007, a continuation-in-part of Ser. No. 11/649,873 entitled A system of calibrating physicians' practices of medicine filed Jan. 5, 2007, a continuation-in-part of Ser. No. 11/637,662 entitled A vital hierarchy of data on diseases filed Dec. 13, 2006, a continuation-in-part of Ser. No. 11/599,847 entitled A hybrid intelligence in medicine filed Nov. 16, 2006, a continuation-in-part of Ser. No. 11/431,046 entitled A system of health-care information management filed Nov. 2, 2006, a continuation-in-part of Ser. No. 11/543,895 entitled Vital elements of speech recognition filed Oct. 6, 2006, a continuation-in-part of Ser. No. 11/523,945 entitled The networking of digital health information filed Sep. 21, 2006, a continuation-in-part of Ser. No. 11/510,820 entitled Words for managing health and health-care information filed Aug. 28, 2006, a continuation-in-part of Ser. No. 11/477,121 entitled the Medical Vocabulary Templates in Speech Recognition filed Jun. 29, 2006, a continuation-in-part of Fidelity of physicians' thoughts to digital data conversions filed Jan. 9, 2006, a continuation-in-part of Ser. No. 11/114,763 entitled A system of influencing health-care utilizations filed Apr. 27, 2005, a continuation-in-part of Ser. No. 11/196,823 entitled Routing of health information files filed Aug. 4, 2005, a continuation-in-part of Ser. No. 11/973,866 entitled An intelligent system of speech recognizing physicians' data, a continuation-in-part of Ser. No. 11/293,689 entitled A system of conserving health-care buyers' resources filed Dec. 5, 2005, a continuation-in-part of Ser. No. 11/150,878 entitled Physicians' optimal management of health information filed Jun. 13, 2005, a continuation-in-part of Ser. No. 11/074,236 entitled A system of management of health-care resources filed Mar. 7, 2005, a continuation-in-part of Ser. No. 11/022,410 entitled Physicians' way of information productions filed Dec. 27, 2004 which are pending and a continuation-in-part of U.S. Pat. No. 6,132,218 entitled Images for communication of medical information in computer granted Oct. 17, 2000 to this present patent applicant.

### FIELD OF INVENTION

The health-care cloud-computing for the most optimal managements of diseases and illnesses for, by and among physicians and patients.

### BACKGROUND OF THE INVENTION

The present invention is the best and most innovative and most intelligent computer-biological electronic-neural system and method in medicine and health-care.

The current health-care system and the practice of medicine and surgery are and remain as archaic and inefficient as those in the past centuries. One of the reasons is the lack of know-how for effecting an effective and practical technological innovation on the most efficient, speedy and accurate or precise deliveries and managements of health, health-care and health-care information, data and health and health-care services—which heretofore are mostly random—for, by and among physicians and people in the current tortuous health-care system.

For billions of people including Americans, in the history of mankind and present, the accesses and availabilities of health-care and managements of diseases, illnesses and disorders from inceptions of diagnoses to treatments or cures and failures, deficiencies and errors wherein patients developed, afflicted, infected, contracted and/or suffered from diseases, illnesses and disorders to the time and moments when they sought health-care, treatments and cures from physicians available to and/or encountered by them in diverse and random settings and circumstances and encounters with physicians are heretofore mostly random processes and events. Said processes and events also involved physicians not knowing, unfamiliar and/or lacks understanding of said diseases, illnesses and disorders, lack skill and/or time for effectively manage, treat, cure and follow-up on said processes due to various factors such as, but not limited to, access to information and data on said issues, matters, entities and patients, knowledge, skills, expertises, time and accesses and related tangible and intangible resources and patients access to physicians in various settings and circumstances. Furthermore, excessive and unnecessary tests are used and consumed thus delaying effective and cost-effective managements and treatments and undesirable and unwanted consequences. Throughout the world, in said primitive and archaic system, millions of random sessions of encountering with physicians related to diseases, illnesses and disorders in said settings and circumstances resulting in inefficient or poor managements, treatments or cures and resultant excessive use of health and health-care resources and failures, deficiencies and errors of managements, cares and follow-up and avoidable or needless morbidity and mortality are common.

On the contrary, the present invention provides the excellent system and method for people including physicians and patients to directly and speedily interact among themselves and computer servers in the Internet of people and computer servers and modern communication devices to directly and speedily secure precise, accurate and vital information of great import on health, health-care information and data and health and health-care services of said people.

Although earlier pending patent applications including said pending applications, of the present applicant help to solve said problems, the present invention further provides more and/or improved system and method for achieving supra. In other words, the present invention reduces or eliminates said random and unnecessary matters, events, issues and encounters inherent to the present and related health and health-care systems and their derivatives and related which adversely affecting the health and health-care, lives, morbidity and mortality of people in America and all nations on earth. Thus, billions of lives will be improved, millions of lives will be saved and billions of dollars lost per annum can and will be saved each year and humanity will be best served by the present invention.

The present invention expedites and improves medical-decision and health-care processes and the managements of health-care services and deliveries of patients to serve said people and humanity and, together with said pending patent applications, are the only means and solution for solving the current health and health-care woes affecting all Americans and, consequently, they produce the best health-care system the world ever known and have and the global benefits for billions of people including physicians and patients and humanity are immense.

### SUMMARY OF THE INVENTION

Most health-care encounters and diagnoses of diseases, illnesses and disorders and related managements including, but not limited to, proper treatments, cures, preventions and related follow-up cares and for billions of patients and physicians are random and chaotic processes albeit disease, illness and disorder processes afflicting human, or animals, are neither random nor chaotic. The fact that, in developed nations and less so in lesser developed nations, individual patients are referred by to other and among medical or surgical physicians by, but not limited to, general practitioners, family physicians, emergency medicine physicians or other specialists is a good representation of supra. The immense intangible and tangible impacts and costs on billions of lives and nations are prevalent and obvious to ones studying medico-economics and socio-economics of health-care on earth.

The present invention causes and transforms millions of inherently or fundamentally random or chaotic encounters between billions of patients and physicians related to encounters and meetings of these people and related managements including diagnoses and related managements including treatments and cures and events, processes and matters of health, well being, morbidity and mortality of billions of people per annum into ordered, guided and precise encounters and meetings and processes of these people and related managements including diagnoses and related managements including treatments and cures.

### DESCRIPTION OF THE PREFERRED EMBODIMENTS

The present invention provides the networks of individual physicians, individual patients, individual groups of physicians and individual groups of physicians and patients in diverse and different settings, circumstances and locations henceforth people and computer servers, teleconferencing platforms including video conferencing henceforth platforms and computers, laptops, hand-held and mobile communication devices and equipment for accessing and interacting with said servers and platforms henceforth devices being used by people networked to said computers servers adaptable to technologically push, pull, forward, disseminate, share and/or stream relational information and data on health and health-care, including laboratory-generated laboratory data, related to, created and generated and submitted by said people to the processor units and memories of said computer servers and compiled and related as said relational information and data in and among SQL tables in SQL databases in and manage by a SQL server in said computer servers wherein said adaptable relational information and data are displayed on the viewing screens and interactive with, among and between and according to for computer servers-guiding and assisting in diagnosing, managing, treating, preventing and controlling diseases, illnesses and disorders and related developments, courses, risks, recurrences, progressions and preventions for, by, among and between said people using said networks.

The present invention provides a network or networks of functioning and operating commercially available computer servers including virtual servers and their derivatives comprising a plurality of processor units, memories, server operating system, said devices and platforms, SQL Server, computer scripting languages, html, various commercially available computer programs and software such as, but not limited to Java, JavaScript, AJAX, HTML, .net, Wordpad, Notepad, .txt, Flash and video enabled programs, various commercial available hardware and equipment such as, but not limited to, routers, switches, modems and commercial and free computer programs and software and source codes for enabling and effecting the networking and processes in the present invention, push, pull, file sharing and streaming technologies and a networking capability for networking said computer servers, devices and platforms and networking capability for technologically pushing, pulling, forwarding, disseminating, sharing and/or streaming said relational information and data on health and health-care by and among said servers, devices and platforms in said networks and, coupled to said hardware and software, the innovative computer programs and software and stored procedures means for instructing, commanding and causing said processor units and memories to repetitively and continually transform random or chaotic events for encountering of, between and among said people seeking information and data on health, health-care, diseases, disorders and illness and related health and health-care services and managements of diseases, illnesses and disorders into ordered, guided and/or efficient encounters and efficient and optimal managements of said diseases, illnesses and disorders, and dispensations and disseminations of said information and data and services of, for, between and among people in diverse and different settings, circumstances and locations and for instantly and continually communicating, disseminating and/or technologically pushing, pulling, streaming and sharing said relational information and data on diagnoses, diseases and illnesses and managing and preventing said diseases, illnesses and disorders for, among and between people in said networks. Said commercial hardware and equipment and computer programs and software and technologies supporting the preferred embodiments of the present invention are briefly identified infra.

Said pending patent applications provide the following preferred embodiments—thoroughly described in said pending patent applications—whose descriptions are summarized in Items 1-7 infra and being used and applied in and further improved by the present invention:

Item 1. The creations and generations of relations and compilations of words, terms, phrases, sentences, 2-dimensional and 3-dimensional representations of body parts, illustrations, figurines, graphics and related word and term headers or headings representing diagnoses and/or syndromes, differential diagnoses and related chief complaints, signs and symptoms and related PQRST, reviews of systems and related PQRST, physical examinations or findings, laboratory results and data, anatomical locations, anatomical sites and organ systems, diagnoses, syndromes, genetics, etiologies, causes, sources and pathologic basis of diseases and illnesses, family histories, travel histories, treatments, surgeries, procedures, assessments and plans, medications, recommendations, advices, referrals and follow-ups and related adjectives and variables and synonyms, acronyms and graphics and related information and data on individual physicians or individual groups of physicians and related qualifying information and data use by physicians of about 85 medical and surgical specialties and practices in computer files by physicians using said devices and/or platforms and submitting said relations and compilations to said processor units and memories from which said relations and compilations are computer server-automatically outputted and said individual words, terms, phrases, sentences, 2-dimensional and 3-dimensional representations of body parts, illustrations, figurines, graphics and related word and term headers or headings are related to individual unique SQL keys and compiled in and among said SQL tables in said SQL databases in and manage by SQL Server.

Item 2. Said innovative computer programs and software and store procedures cause said processor units and memories in said computer servers to create and generate tens of thousands of individual unique SQL units each of which comprises a unique SQL relation and compilation of a unique diagnosis or syndrome related to a unique SQL key to which appropriately related individual unique SQL keys related to said individual words, terms, phrases, sentences, 2-dimensional and 3-dimensional representations of body parts, illustrations, figurines, graphics and related word and term headers or headings related to said information and data on said individual physicians and related individual SQL keys related to said information and data health, health-care and health-care services, diseases, illnesses and disorders in and among said SQL tables in said SQL databases. Each and every SQL unit is unique—no two SQL units in said tens of thousands of unique individual SQL units each of which representing a unique diagnosis or a unique syndrome (or individual groups of diagnoses and/or syndromes) are the same in said tens of thousands of SQL units—by virtue of supra. Synonyms are also similarly accounted for and dealt with by relating related synonyms to related diagnoses and said related in said SQL tables.

Item 3. In other words, said individual unique SQL units each of which comprises a unique SQL relation and compilation of a unique diagnosis or syndrome related to a unique SQL key to which appropriately related individual unique SQL keys related to said individual words, terms, phrases, sentences, 2-dimensional and 3-dimensional representations of body parts, illustrations, figurines, graphics and related word and term headers or headings related to said information and data on said individual physicians and related individual SQL keys related to said information and data health, health-care and health-care services, diseases, illnesses and disorders in and among said SQL tables in said SQL databases. Said innovative computer programs and software and store procedures cause said processor units and memories in said computer servers to create and generate individual unique SQL units by said processor units and memories analyzing, checking, scanning and matching said relations and compilations of said words, terms, phrases, sentences, 2-dimensional and 3-dimensional representations of body parts, illustrations, figurines, graphics and related word and term headers or headings in and among said SQL tables. One of the preferred embodiments of the present invention provides a process for implementing said innovative computer program and software and stored procedures means for creating and generating relations and compilations of words, terms, phrases, sentences, 2-dimensional and 3-dimensional representations of body parts, illustrations, figurines, graphics and related word and term headers or headings representing diagnoses and/or syndromes, differential diagnoses and related chief complaints, signs and symptoms and related PQRST, reviews of systems and related PQRST, physical examinations or findings, laboratory results and data, anatomical locations, anatomical sites and organ systems, diagnoses, syndromes, genetics, etiologies, causes, sources and pathologic basis of diseases and illnesses, family histories, travel histories, treatments, surgeries, procedures, assessments and plans, medications, recommendations, advices, referrals and follow-ups and related adjectives and variables and synonyms, acronyms and graphics and related information and data on individual physicians or individual groups of physicians and related qualifying information and data use by physicians of about 85 medical and surgical specialties and practices in computer files by physicians using said devices and/or platforms and submitting said relations and compilations to said processor units and memories from which said relations and compilations are computer server-automatically outputted and said individual words, terms, phrases, sentences, 2-dimensional and 3-dimensional representations of body parts, illustrations, figurines, graphics and related word and term headers or headings are related to individual unique SQL keys and compiled in and among said SQL tables in said SQL databases in and manage by said SQL Server.

Item 4. Said innovative computer program and software and stored procedures cause said processor units and memories to repetitively scan and check said individual words, terms, phrases and sentences representing individual diagnoses and individual syndromes and related differential diagnoses and related chief complaints, signs and symptoms and related PQRST, reviews of systems and related PQRST, physical examinations or findings, laboratory results and data, anatomical locations, anatomical sites and organ systems, diagnoses, syndromes, genetics, etiologies, causes, sources and pathologic basis of diseases and illnesses, family histories, travel histories, treatments, surgeries, procedures, assessments and plans, medications, recommendations, advices, referrals and follow-ups and related adjectives and variables and synonyms, acronyms and scan, match, analyze and remove redundant duplicates or repeats, doubles related to individual diagnoses or individual syndromes and related said words, terms, phrases and sentences in said individual SQL units in and among said SQL tables in said SQL databases. Consequently, said innovative computer program and software and stored procedures to cause said processor units and memories to assign and relate said individual SQL keys related to said individual words, terms, phrases and sentences representing said individual diagnoses or individual syndromes representing or relating to said individual diagnoses or syndromes, respectively, related to said individual SQL keys in said individual SQL units in and among said SQL tables in said SQL databases in and manage by said SQL Server.

Item 5. Said innovative computer program and software and stored procedures cause said processor units and memories to appropriately assign and relate said all individual SQL keys related to said individual words, terms, phrases and sentences and said related in and among said SQL tables to said tens of thousands of individual SQL units in and among said SQL tables in said SQL databases in and manage by said SQL Server. In other words, said innovative computer program and software and stored procedures caused said processor units and memories to repetitively scan and checking for duplicates or repeats, doubles related to individual diagnoses and individual syndromes and related said relational information and data in and among said SQL tables in said SQL databases in said processor units and memories. Consequently, individual unique SQL units comprising related unique individual SQL keys related to unique individual diagnoses and related unique individual SQL keys related to unique individual chief complaints, signs and symptoms and related individual PQRST, reviews of systems and related individual PQRST, physical examinations or findings, laboratory tests and results and data, anatomical locations, anatomical sites and organ systems, macroscopic anatomy, microscopic anatomy, individual body sites, organ systems, DNA and RNA and biological and disease processes, differential diagnoses, genetics, etiologies, causes, sources and pathologic basis of diseases and illnesses, family histories, travel histories, treatments, surgeries, procedures, assessments and plans, medications, recommendations, advices, referrals and follow-ups and related adjectives and variables and synonyms, acronyms and graphics and related information and data on individual physicians or individual groups of physicians in and among said SQL tables in said SQL databases.

Said innovative computer program and software and stored procedures caused said processor units and memories to create and generate individual relations or associations of said individual SQL keys in and among appropriate said individual SQL units in and among SQL tables in said SQL databases in and manage by said SQL Server.

Item 6. Like said creation and generation of SQL units, a process for computer server-automatically and repetitively scanning and checking for duplicates or repeats, doubles related to said individual chief complaints and related individual unique PQRST, individual signs and related individual unique PQRST, individual symptoms and related individual PQRST, individual reviews of systems and related individual unique PQRST, individual physical examinations or findings, individual laboratory tests and results and data related to said individual unique keys related to said individual diagnoses or individual syndromes in all said SQL units, in and among said SQL tables in said SQL databases, in said processor units and memories. Consequently, said individual chief complaints, individual signs, individual symptoms and related individual PQRST, individual reviews of systems and related individual PQRST, individual physical examinations or findings, individual laboratory tests and results and DNA and RNA and biological and disease processes and events related to individual unique SQL keys and related to individual unique SQL keys related to individual unique anatomical locations, macroscopic anatomy, microscopic anatomy, individual body sites, organ systems, DNA and RNA and biological and disease processes and events in said processor units and memories and in said SQL tables in said SQL databases. The assigning of said relations and compilations can be achieved either by human creating said relations and compilations in the .txt and/or html documents on the viewing screens of said devices and/or by said innovative computer programs and software.

Said preferred embodiments, therefore, enabled a process for computer server creating and generating individual unique words, terms, phrases or sentences representing individual unique chief complaints and individual unique PQRST and related individual SQL keys each of which are related to clinically relevant individual unique SQL keys related to individual unique anatomical locations, macroscopic anatomy, microscopic anatomy, individual body sites, organ systems, DNA and RNA and biological and disease processes and events in said SQL tables in said SQL databases; a process for computer server creating and generating individual unique words, terms, phrases or sentences representing individual unique signs and individual unique PQRST and related individual SQL keys each of which are related to clinically relevant individual unique SQL keys related to individual unique anatomical locations, macroscopic anatomy, microscopic anatomy, individual body sites, organ systems, DNA and RNA and biological and disease processes and events in said SQL tables in said SQL databases; a process for computer server creating and generating individual unique words, terms, phrases or sentences representing individual unique symptoms and individual unique PQRST and related individual SQL keys each of which are related to clinically relevant individual unique SQL keys related to individual unique anatomical locations, macroscopic anatomy, microscopic anatomy, individual body sites, organ systems, DNA and RNA and biological and disease processes and events in said SQL tables in said SQL databases; a process for computer server creating and generating individual unique words, terms, phrases or sentences representing individual unique reviews of systems and individual unique PQRST and related individual SQL keys each of which are related to clinically relevant individual unique SQL keys related to individual unique anatomical locations, macroscopic anatomy, microscopic anatomy, individual body sites, organ systems, DNA and RNA and biological and disease processes and events in said SQL tables in said SQL databases; a process for computer server creating and generating individual unique words, terms, phrases or sentences representing individual unique physical examinations and related individual SQL keys each of which are related to clinically relevant individual unique SQL keys related to individual 2-dimensional and 3-dimensional representations of body parts, illustrations, figurines, graphics, highlights, contrasts, the macroscopic anatomy, microscopic anatomy, individual body sites, organ systems, DNA and RNA and biological and disease processes and events in said SQL tables in said SQL databases; and a process for computer server creating and generating individual unique words, terms, phrases or sentences representing individual unique laboratory testing and results and related individual SQL keys each of which are related to clinically relevant individual unique SQL keys related to individual unique anatomical locations, macroscopic anatomy, microscopic anatomy, individual body sites, organ systems, DNA and RNA and biological and disease processes and events in said SQL tables in said SQL databases.

In other words, there are hundreds of thousands of individual unique chief complaints and related individual PQRST, individual unique symptoms and related individual PQRST, individual unique signs and related individual PQRST, individual unique reviews of systems and related individual PQRST, individual unique physical examinations and individual unique laboratory tests and results and data and related individual unique SQL keys—related to said hundreds of thousands unique SQL keys relate to said tens of thousands of individual unique diagnoses in said tens of thousands of SQL units—related to individual SQL keys related to individual unique anatomical locations, macroscopic anatomy, microscopic anatomy, individual body sites, organ systems, DNA and RNA and biological and disease processes and events in and among said SQL tables.

Said preferred embodiments applied to DNA and RNA and biological and disease processes and events.

Item 7. One of the preferred embodiments of said pending patent application number 13/065,518 entitled Brains-empowered networking provides for said innovative computer program and software and stored procedures to cause said processor units and memories to create, generate and display a plurality of interactive related electronic Plasmids in said viewing screens of said devices and/or platforms being used by said people in said networks.

Uniquely, said pending patent application provides for the creation and generation individual SQL relations and compilations comprising said individual unique SQL keys related to clinically relevant individual SQL keys related to individual unique anatomical locations, macroscopic anatomy, microscopic anatomy, individual body sites, organ systems, DNA and RNA and biological and disease processes and events in said SQL tables in said SQL databases comprises individual relation and compilation of SQL keys related to individual unique words, terms, phrases or sentences representing individual unique chief complaints and related PQRST related to individual unique SQL keys related to individual unique anatomical locations, macroscopic anatomy, microscopic anatomy, individual body sites, organ systems, DNA and RNA or biological and disease processes and events and individual unique keys related to individual diagnoses and individual syndromes—henceforth known individual electronic scan-and-search, chief complaint-body site plasmids or individual CCBPs—in processor units and memories and in said SQL tables in said SQL databases; individual relation and compilation of SQL keys related to individual unique words, terms, phrases or sentences representing individual unique signs and related PQRST related to individual unique SQL keys related to individual unique anatomical locations, macroscopic anatomy, microscopic anatomy, individual body sites, organ systems, DNA and RNA or biological and disease processes and events and individual unique keys related to individual diagnoses and individual syndromes—henceforth known individual electronic scan-and-search, sign-body site plasmids or individual SNBPs—in processor units and memories and in said SQL tables in said SQL databases; individual relation and compilation of SQL keys related to individual unique words, terms, phrases or sentences representing individual unique symptoms and related PQRST related to individual unique SQL keys related to individual unique anatomical locations, macroscopic anatomy, microscopic anatomy, individual body sites, organ systems, DNA and RNA or biological and disease processes and events and individual unique keys related to individual diagnoses and individual syndromes—henceforth known individual electronic scan-and-search, symptom-body site plasmids or individual SMBPs—in processor units and memories and in said SQL tables in said SQL databases; individual relation and compilation of SQL keys related to individual unique words, terms, phrases or sentences representing individual unique review of systems and related PQRST related to individual unique SQL keys related to individual unique anatomical locations, macroscopic anatomy, microscopic anatomy, individual body sites, organ systems, DNA and RNA or biological and disease processes and events and individual unique keys related to individual diagnoses and individual syndromes—henceforth known individual electronic scan-and-search, symptom-body site plasmids or individual RSBPs—in processor units and memories and in said SQL tables in said SQL databases; individual relation and compilation of SQL keys related to individual unique words, terms, phrases or sentences representing individual unique physical examinations related to individual unique SQL keys related to individual unique anatomical locations, macroscopic anatomy, microscopic anatomy, individual body sites, organ systems, DNA and RNA or biological and disease processes and events and individual unique keys related to individual diagnoses and individual syndromes—henceforth known individual electronic scan-and-search, physical examination-body site plasmids or individual PEBPs—in processor units and memories and in said SQL tables in said SQL databases; individual relation and compilation of SQL keys related to individual unique words, terms, phrases or sentences representing individual unique laboratory tests and results related to individual unique SQL keys related to individual unique anatomical locations, macroscopic anatomy, microscopic anatomy, individual body sites, organ systems, DNA and RNA or biological and disease processes and events and individual unique keys related to individual diagnoses and individual syndromes—henceforth known individual electronic scan-and-search, laboratory test and result-body site plasmids or individual LBBPs—in processor units and memories and in said SQL tables in said SQL databases.

Further to supra, said pending patent application provides for the creation and generation of said SQL relations and compilations of said individual unique SQL keys related to clinically relevant individual SQL keys related to individual unique anatomical locations, macroscopic anatomy, microscopic anatomy, individual body sites, organ systems, DNA and RNA and biological and disease processes and events in said SQL tables in said SQL databases in said viewing screens of said computers, laptops, hand-held and mobile devices and equipment in said network or networks by and among physicians and patients using computers, laptops, hand-held and mobile devices and equipment.the present invention provides for the generations, retrievals and displays of interactive said individual CCBPs, interactive said individual SNBPs, interactive said individual SMBPs, interactive said individual RSBPs, interactive said individual PEBPs, interactive said individual LBBPs and any combination thereof in a plurality of individual adaptable interactive linked electronic templates, pop-up and drop-down comprising said individual CCBPs, individual SNBPs, individual SMBPs, individual RSBPs, individual PEBPs and/or individual LBBPs body-site-related, body-site-associated with or clinically relevant to interactive words, terms, phrases, sentences, 2-dimensional and 3-dimensional representations of body parts, illustrations, figurines, graphics, highlights, contrasts, representing the macroscopic anatomy, microscopic anatomy, individual body sites, organ systems, DNA and RNA and/or biological and disease processes and events in said viewing screens of said computers, laptops, hand-held and mobile devices and equipment, upon pointing cursors with mice and/or fingers in said interactive words, terms, phrases, sentences, 2-dimensional and 3-dimensional representations of body parts, illustrations, figurines, graphics, highlights, contrasts, macroscopic anatomy, microscopic anatomy, individual body sites, organ systems, DNA and RNA and/or biological and disease processes and events in said viewing screens by and among physicians and patients using computers, laptops, hand-held and mobile devices and equipment.

A plurality of individual adaptable interactive linked electronic templates, pop-up and drop-down comprising said individual unique SQL units in and among said SQL tables in said SQL databases from said relations and compilations of individual unique SQL keys related to individual words, terms, phrases, sentences, 2-dimensional and 3-dimensional representations of body parts, illustrations, figurines, graphics and related word and term headers or headings according to said innovative computer programs and software and stored procedures in said processor units and memories and computer server-automatically outputted to and related in and among said SQL tables in said SQL Server upon by said physicians and/or patients pointing of cursors, selecting, clicking and/or keyboarding in said viewing screens by or by and among said physicians and/or patients. Consequently, the preferred embodiments of the present invention provides for computer server-automatic generations, retrievals and displays of interactive said individual unique chief complaints and related PQRST associated with said interactive said individual CCBPs, interactive said individual unique signs and related PQRST associated with said interactive said individual SNBPs, interactive said individual unique symptoms and related interactive PQRST associated with said interactive said individual SMBPs, interactive said individual unique review of systems and related interactive PQRST associated with said interactive said individual RSBPs, interactive said individual unique physical examinations associated with said interactive said individual PEBPs, interactive said individual unique laboratory tests and results associated with said interactive individual LBBPs and any combination thereof in said plurality of individual adaptable interactive linked electronic templates, pop-up and drop-down comprising said individual CCBPs, individual SNBPs, individual SMBPs, individual RSBPs, individual PEBPs and/or individual LBBPs body-site-related, body-site-associated with or clinically relevant to interactive words, terms, phrases, sentences, 2-dimensional and 3-dimensional representations of body parts, illustrations, figurines, graphics, highlights, contrasts, representing the macroscopic anatomy, microscopic anatomy, individual body sites, organ systems, DNA and RNA and/or biological and disease processes and events in said viewing screens of said computers, laptops, hand-held and mobile devices and equipment by and among physicians and patients using computers, laptops, hand-held and mobile devices and equipment, upon pointing cursors with mice and/or fingers in said interactive words, terms, phrases, sentences, 2-dimensional and 3-dimensional representations of body parts, illustrations, figurines, graphics, highlights, contrasts, macroscopic anatomy, microscopic anatomy, individual body sites, organ systems, DNA and RNA and/or biological and disease processes and events in said viewing screens by and among physicians and patients using computers, laptops, hand-held and mobile devices and equipment, enabled by JavaScript, AJAX and HTML, Flash programs and said innovative computer programs and software, stored procedures, Web browsers and Web server.

In passing, it is to be understood that said plasmid and plasmids are metaphor used supra to facilitate understanding of said preferred embodiments, means and method—and their derivatives and adaptations—of the present invention. In reality, as described supra, said metaphor representing SQL relations and compilations of SQL keys related to said individual unique words, terms, phrases or sentences representing individual unique chief complaints and related PQRST related to individual unique SQL keys related to individual unique anatomical locations, macroscopic anatomy, microscopic anatomy, individual body sites, organ systems, DNA and RNA or biological and disease processes and events and individual unique keys related to individual diagnoses and individual syndromes in processor units and memories and in and among said SQL tables in said SQL databases.

The present invention provides the following preferred embodiments for achieving the goals and objectives in the claims of the present invention:

One of the preferred embodiments of the present invention provides said innovative computer program and software and stored procedures to repetitively cause said processor units and memories to automatically scan, analyze and match said relations and compositions of individual interactive unique words, terms, phrases or sentences ordered and displayed according to said numerical degrees of said relations or associations in said Plasmids and submitted to said processor units and memories by, among and/or between said physicians, using said devices and/or platforms, with said individual unique words, terms, phrases or sentences in said individual SQL units in said processor units and memories and outputting individual outcomes of said scans, analyses and matches comprising information and data on and related to information and data on physicians, diagnoses, syndromes, individual groups of diagnoses, differential diagnoses, diseases, disorders and illness and related health, health-care, health-care services and managements of diseases, illnesses and disorders and related information and data on physicians and related files in said viewing screens of said devices and platforms and in said SQL databases.

In addition to said preferred embodiments of said pending patent applications, one of the preferred embodiments of the present invention provides for said process for said innovative computer program and software and stored procedures to cause said processor units and memories to retrieve, order and display said relations and compilations of interactive said unique words, terms, phrases or sentences as individual hierarchies of adaptable positions or ranking of said unique words, terms, phrases or sentences in and among individual said interactive related electronic Plasmids and preponderance, predominant orders or ranks or positions of said Plasmids in said viewing screens based on said numerical degrees of said relations or associations of and among said individual unique words, terms, phrases or sentences—generated and created by and among physicians using said devices and platforms—related to appropriate individual SQL units and individual diagnoses and related individual SQL keys in and among SQL tables in said SQL databases.

Said innovative computer programs and software and stored procedures to cause said processor units and memories to repetitively generate and display individual panels for logging and displaying said relations and compilations in said viewing screens with successive clicking of said individual unique words, terms, phrases or sentences in said interactive related Plasmids by and among said people who can refer to said logs for references on said successive and sequential clicking of said individual unique words, terms, phrases or sentences. For example, said logs comprise chronological ordered selected and clicked chief complaints and related individual PQRST, said selected and clicked signs and related individual PQRST and said selected and clicked symptoms and related individual PQRST and individual unique physical examinations and individual unique laboratory tests and results and data as consequences of individual successive or sequential selections, clicks and generations of relations and compilations of said individual interactive unique words, terms, phrases or sentences in and among said interactive electronic Plasmids in said viewing screens by and among said people. Different orders of selects and clicks for creating and generating said relations and compilations of influence and post different outcomes of the present invention.

Said individual hierarchies of adaptable positions or ranking of said unique words, terms, phrases or sentences in and among individual said interactive related electronic Plasmids and preponderance, predominant orders or ranks or positions of said Plasmids in said viewing screens instantly influence adaptable clinical decisions and consequent actions of said of individual physicians or individual groups of physicians using said plasmids and consequently, the outcomes—relations of individual diagnoses, individual or individual groups of related diseases, disorders and illnesses and related health and health-care services and related managements of said diseases, illnesses and disorders and related information and data by, between and among physicians, dispensations, disseminations and file sharing of said information and data on diagnoses, diseases and illnesses and efficient and optimal managements, preventions and controls of said diseases, illnesses and disorders and related health-care services and cares by, among and between said people, and the transformations of random or chaotic processes for encountering of, between and among people seeking information and data on health, health-care, diseases, disorders and illness and related health and health-care services and managements of diseases, illnesses and disorders and related information and data on physicians into computer-servers ordered, guided and/or efficient encounters of, between and among said people in diverse settings, circumstances and locations—as described infra and in the claims of the present invention.

Said hierarchies of adaptable positions or ranking of said unique words, terms, phrases or sentences in and among individual said interactive related electronic Plasmids and preponderance, predominant orders or ranks or positions of said Plasmids in said viewing screens are created and generated by a process for said innovative computer program and software and stored procedures causing said processor units and memories to create and generate individual unique relations and compilations of related individual SQL keys related to said individual unique words, terms, phrases or sentences in and among said Plasmids in and among in and among SQL tables in said SQL databases upon submissions of relations and compilations of said individual unique words, terms, phrases or sentences to said processor units and memories by physicians using said devices and/or platforms. Said innovative computer program and software and stored procedures cause said processor units and memories to analyze, calculate and tally the frequencies, degrees, preponderance or prevalence in said SQL tables in said SQL databases of individual relations or associations of and among related said unique words, terms, phrases or sentences related to individual unique anatomical locations, macroscopic anatomy, microscopic anatomy, individual body sites, organ systems, DNA and RNA and biological and disease processes and events in said relations and compilations generated by, among and/or between said people using said devices and/or platforms and tabulated as numerical degrees of said relations or associations in said SQL tables in said SQL databases. Consequently, said innovative computer program and software and stored procedures cause said processor units and memories to repetitively retrieve and display said interactive said unique words, terms, phrases or sentences and said related Plasmids in preponderance, predominant orders or ranks based on said numerical degrees of said relations or associations of interactive said unique words, terms, phrases or sentences in and among individual said interactive related electronic Plasmids in said viewing screens and/or platforms.

One of the preferred embodiments of the present invention provides a process for said innovative computer program and software and stored procedures to cause said processor units and memories to create and generate and display individual unique interactive patients' words, terms, phrases or sentences in the viewing screens by, among and/or between patients or non-physicians although physicians may achieve also supra. This preferred embodiment enable and effect the communications of patients' words, terms, phrases and sentences in English or other languages representing chief complaints, signs and symptoms and related PQRST, family histories, travel histories, treatments, surgeries, procedures, assessments and plans, medications, recommendations, advices, referrals and follow-ups and related adjectives and variables and synonyms related to 2-dimensional and 3-dimensional representations of body parts, illustrations, figurines, graphics, highlights, contrasts, representing the macroscopic anatomy, microscopic anatomy, individual body sites, organ systems, DNA and RNA and/or biological and disease processes and events in said viewing screens and submitting selections and compilations of said keyboarded, touch-screened and/or voiced patients' words, terms, phrases, sentences to said processor units and memories of said computer servers using said devices and/or platforms in said networks.

Supra is achieved by a process for said innovative computer program and software and stored procedures to cause said processor units and memories to repetitively scan, check, analyze and match said individual words, terms, phrases and sentences to remove redundant duplicates or repeats, doubles in and among SQL tables in said SQL databases; and, consequently, to cause said processor units and memories analyze, calculate and tally the frequencies, degrees, preponderance or prevalence of individual relations or associations of said patients' words, terms, phrases and sentences related to individual body sites, parts, illustrations, figurines, graphics in said patients' description of diseases, illnesses and disorders and said related used by and among said patients using said devices and/or platforms and tabulated as numerical degrees of said prevalence of uses or preponderance of uses of said individual words, terms, phrases and sentences related to said individual body sites, parts, illustrations, figurines, graphics in said SQL tables in said SQL databases;

Said patients' communications are created and generated by said innovative computer program and software and stored procedures cause said processor units and memories to retrieve and display individual adaptable interactive linked electronic templates, pop-ups and drop-downs for keyboarding relevant said words, terms, phrases, sentences in English or other languages representing chief complaints, signs and symptoms and related PQRST, family histories, travel histories, treatments, surgeries, procedures, assessments and plans, medications, recommendations, advices, referrals and follow-ups and related adjectives and variables and synonyms related to 2-dimensional and 3-dimensional representations of body parts, illustrations, figurines, graphics, highlights, contrasts, representing the macroscopic anatomy, microscopic anatomy, individual body sites, organ systems, DNA and RNA and/or biological and disease processes and events in said viewing screens and submitting selections and compilations of said keyboarded by said individual patients to said processor units and memories.

In other words, said innovative computer program and software and stored procedures and said processor units and memories causing repetitive retrievals and displays in said viewing screens adaptable relations and compilations of said interactive said unique patients' words, terms, phrases or sentences related to word and term headers or headings, 2-dimensional and 3-dimensional representations of body parts, illustrations, figurines, graphics, highlights, contrasts, macroscopic anatomy, microscopic anatomy, individual body sites, organ systems, DNA and RNA and/or biological and disease processes and events in alphabetical and logically prevalent orders or ranks based on said numerical degrees of said prevalence of uses or preponderance of uses of said individual words, terms, phrases and sentences related to said individual body sites, parts, illustrations, figurines, graphics by and among said people in said SQL tables in said SQL databases in said viewing screens and/or platforms.

Said individual hierarchies of adaptable positions or ranking of said patients' words, terms, phrases or sentences in said viewing screens instantly influence adaptable decisions and consequent actions of said of individual patients or individual groups people and consequently, the outcomes—relations of individual diagnoses, individual or individual groups of related diseases, disorders and illnesses and related health and health-care services and related managements of said diseases, illnesses and disorders and related information and data by, between and among people and dispensations, disseminations and file sharing of said information and data on diagnoses, diseases and illnesses and efficient and optimal managements, preventions and controls of said diseases, illnesses and disorders and related health-care services and cares by, among and between said people, and the transformations of random or chaotic processes for encountering of, between and among people seeking information and data on health, health-care, diseases, disorders and illness and related health and health-care services and managements of diseases, illnesses and disorders and related information and data on physicians into computer-servers ordered, guided and/or efficient encounters of, between and among said people in diverse settings, circumstances and locations—as described infra and in the claims of the present invention.

In summary, as it is well described in the claims of the present invention, to achieve the goals and objectives of the present invention, one of the preferred embodiments of the present invention provides a process for said innovative computer program and software and stored procedures to cause said processor units and memories to create and generate the outcomes of the present invention by applying in a plurality of individual adaptable interactive linked electronic templates, pop-ups, drop-downs, in said interactive related electronic Plasmids and in and among SQL tables in said SQL databases and in said processor units and memories:
i. numerical degrees of preponderance or prevalence of uses of said individual patients' words, terms, phrases and sentences related to said chief complaints, signs and symptoms and related PQRST and related individual anatomical sites,
ii. numerical degrees of said relations or associations of and among said individual unique words, terms, phrases and/or sentences, and
iii. numerical degrees of preponderance or prevalence of relations or associations of said individual patients' words, terms, phrases and sentences with said individual unique words, terms, phrases or sentences in and among SQL tables in said SQL databases with which individual relations and compilations of patients' words, terms, phrases and sentences, individual relations and compilations unique words, terms, phrases and sentences and any combinations thereof are created and generated by, among and/or between said people and are submitted to and repetitively and continually analyzed, scanned, checked and matched with said individual SQL units according to said numerical degrees by said processor units and memories to achieve the goals and objectives of the present invention which are to most efficiently and optimally:
relate individual diagnoses related to individual or individual groups of related and/or unrelated diseases, disorders and illnesses and related health and health-care services and managements of said diseases, illnesses and disorders and related information and data by, between and among people in diverse settings, circumstances and locations;
transform random or chaotic processes for encountering of, between and among people seeking information and data on health, health-care, diseases, disorders and illness and related health and health-care services and managements of diseases, illnesses and disorders and related information and data on physicians into computer-servers ordered, guided and/or efficient encounters of, between and among said people; and
to dispense, disseminate and share said information and data on diagnoses, diseases and illnesses and efficient and optimal managements, preventions and controls of said diseases, illnesses and disorders and related health-care services and cares by, among and between said people; and
to instantly diagnosing, managing and coordinating treatments, cares, preventions and controls of diseases, disorders and illnesses for, by and among patients and physicians by instantly and continually communicating, disseminating, sharing, said information and data on diagnoses, diseases and illnesses and managements and preventions said diseases, illnesses and disorders for, among and between patients and physicians in said networks.

The present invention provides operating and functioning said computer servers possessing and operating memories, processors, at least a server operating system, a Windows Server, a SQL Server and computer scripting languages coupled to the innovative computer programs and software infra, a Visual Studio and .Net, Java script, AJAX, HTML, XHTML, Flash and video, a Microsoft IIS, Apache, a Web browser, Web server and possessing and operating the present applicant's invented innovative computer programs and software for commanding and communicating for commanding and communicating with said SQL Server and said relational database and/or databases and coupling with said computer scripting languages and said innovative computer programs and software for creating and generating a plurality of individual interactive and adaptable related electronic templates, a plurality of interactive pop-up and/or drop-down lists and/or menus of words, terms, phrases, sentences, texts, synonyms, acronyms, texts, numbers, graphics, and word and term headers or headings comprising information and data on and relating to said diagnoses on diseases, disorders, health, health-care and health-care services in categories of chief complaints, signs and symptoms, reviews of systems, physical examinations or findings, laboratory results, anatomical locations, anatomical sites and organ systems, diagnoses, differential diagnoses, treatments, assessments and plans, recommendations, advices, referrals and follow-ups henceforth information and data use by physicians of about 85 medical and surgical specialties and practices, for creating, generating, expanding and improving SQL databases and tables comprising relational SQL keys related to said words and terms representing said in said SQL databases and tables in said SQL Server, for creating, compiling, pooling and relating relational information and data in said SQL databases and tables and relational SQL units, for repetitively scanning and checking for redundant duplicates or repeats, doubles in individual physicians' submissions related to individual diagnoses or individual syndromes or diagnoses in individual groups of diagnoses and related relational information and data in said SQL databases and tables, for removing said redundant duplicates or repeats, doubles from relational information and data from said SQL databases, tables and said relational SQL units and for not inserting said redundant duplicates or repeats, doubles into said relational information and data in said SQL databases and tables and relational SQL units, for creating, generating and maintaining said relational SQL units comprising relational SQL keys in said SQL databases and tables comprising plurality of said information and data tables, for creating, generating and maintaining individual unique relational SQL units comprising said relational SQL keys, for creating, generating and maintaining said unique relational SQL units comprising said relational SQL keys without redundant repeats and duplicates of SQL keys in said relational SQL units, for generating queries for said information on individual information on individual physicians' identities and practices and individual diagnoses and related treatments and differential diagnoses by people, for enabling said computer server or servers to process the relations of said words and terms and said relational SQL units and words and terms in said queries in said SQL Server and in said memories of said computer server or servers, for providing and instructing computer server or servers to execute algorithms for processing said relations of said words and terms and said relational SQL units and words and terms in said queries in said SQL Server and in said memories of said computer server or servers, for providing and instructing computer server or servers to sequentially scan and match said words and terms and said relational SQL units and words and terms in said queries, for providing and instructing computer server or servers to sequentially select said information on individual physicians' identities and practices and specialties individual diagnoses and related treatments and differential diagnoses on viewing screens and for providing and enabling said computer server or server to display said information on individual physicians' identities and practices and specialties individual diagnoses and related treatments and differential diagnoses on viewing screens.

The present invention provides said innovative computer programs and software invented by the present patent applicant which were filed with and are stored in the Library of Congress in Washington, D.C. The present invention uses also the commercially available computer software (plural), programs and computer languages such as, but not limited to, those made and sold by Adobe Systems, Inc. such as, but not limited to, Flash and Flash video and streaming technologies and Microsoft Corporation such as, but not limited to, Microsoft Windows Server operating system, Chrome operating system, Linux, SQL servers such as, but not limited to Microsoft SQL Server, MySQL and the like, Internet Explorer, various other Web browsers such as, but not limited to Firefox browser by Mozilla Foundation, Chrome Web browser, Safari, Opera and derivatives, Web server, Apache, Microsoft IIS, Visual Studio and .Net, Microsoft software including Notepad, Wordpad and .txt programs and their derivatives and the like and related and their database, databases and derivatives, other computer corporations' and companies' programs, languages, codes and databases and their derivatives which are commonly and routinely used by computer engineers and programmers such as, but not limited to, PHP, PERL, C languages, such as, but not limited to, C, C+, C++, C#, JAVA, Java Script, AJAX, HTML, XHTML JavaScript, AJAX, HTML, .net, Wordpad, Notepad, .txt, Flash and video enabled programs and the like and related and their derivatives. Other computer programs and software also include application software (plural) also known as Applications or Apps for manipulating, texting, numbering, graphics, or any combinations of these elements for uses and applications with iPhone and iPad of Apple, Inc. and Google's Android software. Other security software are such as, but not limited to, encryption-decryption of the information and data infra and their derivatives and products, processes and software, Firewall, anti-viral and related, Secure Sockets Layer (SSL) or Transport Layer Security (TLS) and related and the like and their derivatives.

The standard commercial hardware and equipment being used in the TCP/IP networks and the like or equivalence such as, but not limited to, the Internet commerce are implemented and deployed per standard industrial practices and use hardware and equipment such as, but not limited to, computer servers and computers such as numerous HP and IBM servers, HP and Dell computers, Cisco routers and related, and various equipment including modems sold, lease, own and operate by cable companies such as, but not limited to, Time Warner and Optimum Online in New York, etc. Currently, HP ProLiant ML350 and ML110 Generation 4p Servers—see www.hp.com for details of the server hardware and internal design—and similar Dell server—see www.dell.com for details of the server hardware and internal design—used by the present patent applicant as the hardware wherein the computer programs and software(s) mentioned herein operate.

It is to be understood that said computer servers of the present invention also further embodied any and all computers and mobile computers such as, but not limited to, and server blades and various hardware and equipment configurations, virtual servers such as those sold by VMware, HP and IBM, and their derivatives being used by many large American corporations can and will be used to implement the present invention. Furthermore, it is to be understood that computer or computers in the claims infra may also implied computer server, computer servers, virtual server, virtual servers.

Said preferred embodiments of the present invention are applicable to and used by individual physicians, individual patients, individual groups of physicians and individual groups of physicians and individual patients in same and diverse and different settings and locations. In other words, the preferred embodiments of the present invention are also enabled by popular commercial technologies provided www.webex.com by Cisco Systems, Inc. and www2.gotomeeting.com by Citrix Online, L.L.C. and the like provided by other companies or corporations for enabling individual persons in various and different settings and locations to conference or use said embodiments as individual groups of people being in said diverse or different settings and locations using said network or networks and the Internet to achieve the goals and objectives of the present invention. Said programs and software and the derivatives and the like enabled individuals and individual groups of people to use and apply the present invention.

Further to supra, the present invention can incorporate, use and/or network with Skype—which was recently acquired by Microsoft Corp. in 2011 as Microsoft Skype Division and the like products and derivatives—to achieve the goals and objectives of the present invention.

However, the preferred embodiments of said pending patent applications supra and present invention and other pending applications of the present patent applicant motivated and caused the development and present implementation of clients-server system—all or almost all matters, events and communications of, by, among and between patients and physicians using said devices in USA and all over the world—are implemented and occurring in said network or networks of computer servers and virtual servers including push, pull, file sharing and streaming technologies using commercially available program and software, such as, but not limited to, the Comet technology being sold by several companies such as, LightStreamer—http://www.lightstreamer.com—and the like and their derivatives and related for technologically push and pull for streaming and disseminating and propagating said outcomes including real-time information and data as described in the preferred embodiments of the present invention to said devices and platforms and other computer servers if linked to said networks. Said preferred embodiments also motivate and cause the sooner implementations of teleconferencing and video conferencing in and to occur in the system of network or networks of computer servers and devices so claimed in the claims of the present invention infra and said pending patent applications. Furthermore, said teleconferencing and videoconferencing also include, but not limited to, multipoint videoconferencing, instant messaging and mobile instant messaging.

Although the present invention is a vital component of the Cloud Healthcare Exchange created and formed by various pending patent applications of and the innovative computer programs and software invented, created, matured and applied by of the present patent applicant coupled to various commercially available computer hardware and equipment and various computer programs and software and technologies, one of the preferred embodiments of the present invention provides human civilization with the networks of patients and physicians and computer servers, teleconferencing platforms including video conferencing henceforth platforms and computers, laptops, hand-held and mobile communication devices and equipment—comprise keyboards and viewing screens including touch-enabled viewing screens or touch-screens and speech recognition technologies—enabled by Web browsers and said Web server in said network or networks for accessing and interacting with said servers and platforms henceforth devices being used by patients and physicians networked to said servers adaptable to technologically push, pull, forward, disseminate, share and/or stream relational information and data on health and health-care described herein. However, by default and the immensity of the present invention, clients to computer servers in said networks or cloud computing may depend on said push and pull as all events and matters and outcomes will occur and execute with said networks.

Although sequences of applications of individual interactive words and terms representing diagnoses, syndromes and diagnoses or syndromes in individual groups of diagnoses or syndromes and compiled, related or pooled relational information and data on and related to diagnoses, syndromes and diagnoses or syndromes in individual groups of diagnoses or syndromes and related chief complaints, symptoms and signs, differential diagnoses, reviews of systems, physical examinations, family histories, genetics, immunizations, laboratories, imaging, body fluid tests and tissues examinations, assessments and plans, medications, treatments, procedures, surgeries, recommendations, guidelines, referrals, follow-ups, organs and anatomical sites and parts of humans and physicians' practices related to said diagnoses or said individual groups of diagnoses as one of the preferred embodiments of the present invention have been described, it is to be appreciated and understood by those skilled in the art that various combinations, permutations and orders of sequences of applications of said words, terms and phrases are some of the preferred embodiments of the present invention and are made, used and achieved without departing from the spirit and the scope of the claims of the present invention.

It is to be understood that the system and method taught by U.S. Pat. No. 6,132,218 entitled Images for communication of medical information in computer granted Oct. 17, 2000 to this present patent applicant will be incorporated into said preferred embodiments of the present invention to achieve the goals and objectives of the present invention.

It is to be understood that the present invention provides also voice-enabled means for interacting such as, but not limited to, speech recognition technology, Voice over Internet Protocol, IP telephony, Internet telephony, voice over broadband (VoBB), broadband telephony and broadband phone in said preferred embodiments.

Although the preferred embodiments of this invention have been described for humans, it will be appreciated by those skilled in the art that adaptations and variations of the present invention may be made to apply to other species, animals, biological entities or structures, infectious particles or structures, and machines without departing from the spirit of the invention and the scope of the claims.

Although various preferred embodiments and representations of the present invention have been described, it will be appreciated by those skilled in the art that the real and practical implementations and their adaptations, variations and derivatives are and will be made and achieved without departing from the spirit and the scope of the claims of the present invention.

1. The networks of patients and physicians and computer servers, teleconferencing platforms including video conferencing henceforth platforms and computers, laptops, hand-held and mobile communication devices and equipment for accessing and interacting with said servers and platforms henceforth devices being used by patients and physicians networked to said servers adaptable to technologically push, pull, forward, disseminate, share and/or stream relational information and data on health and health-care, including laboratory-generated laboratory data, related to, created and generated and submitted by said people to the processor units and memories of said computer servers and compiled and related as said relational information and data in and among SQL tables in SQL databases in and manage by a SQL server in said computer servers wherein said adaptable relational information and data are displayed on the viewing screens and interactive with, among and between and according to individual physicians, individual patients, individual groups of physicians and individual groups of physicians and patients in diverse and different settings, circumstances and locations henceforth people for computer servers-guiding and assisting in diagnosing, managing, treating, preventing and controlling diseases, illnesses and disorders and related developments, courses, risks, recurrences, progressions and preventions for, by, among and between said people using said networks comprises:
said functioning and operating computer servers including virtual servers comprising a plurality of processor units, memories, server operating system, said devices and platforms, SQL Server, computer scripting languages, html, various commercially available hardware including, but not limited to, routers, switches, modems and commercial and free computer programs and software and source codes for enabling and effecting the networking and processes in the present invention, push, pull, file sharing and streaming technologies and a networking capability for networking said computer servers, devices and platforms and networking capability for technologically pushing, pulling, forwarding, disseminating, sharing and/or streaming said relational information and data on health and health-care by and among said servers, devices and platforms in said networks and, coupled to said hardware and software, the innovative computer programs and software and stored procedures means for instructing, commanding and causing said processor units and memories to repetitively and continually transform random or chaotic events for encountering of, between and among said people seeking information and data on health, health-care, diseases, disorders and illness and related health and health-care services and managements of diseases, illnesses and disorders into ordered, guided and/or efficient encounters and efficient and optimal managements of said diseases, illnesses and disorders, and dispensations and disseminations of said information and data and services of, for, between and among people in diverse and different settings, circumstances and locations and for instantly and continually communicating, disseminating and/or technologically pushing, pulling, streaming and sharing said relational information and data on diagnoses, diseases and illnesses and managing and preventing said diseases, illnesses and disorders for, among and between people in said networks;
relations and compilations of words, terms, phrases, sentences, 2-dimensional and 3-dimensional representations of body parts, illustrations, figurines, graphics and related word and term headers or headings representing diagnoses and/or syndromes, differential diagnoses and related chief complaints, signs and symptoms and related PQRST, reviews of systems and related PQRST, physical examinations or findings, laboratory results and data, anatomical locations, anatomical sites and organ systems, diagnoses, syndromes, genetics, etiologies, causes, sources and pathologic basis of diseases and illnesses, family histories, travel histories, treatments, surgeries, procedures, assessments and plans, medications, recommendations, advices, referrals and follow-ups and related adjectives and variables and synonyms, acronyms and graphics and related information and data on individual physicians or individual groups of physicians and related qualifying information and data use by physicians of about 85 medical and surgical specialties and practices in computer files by physicians using said devices and/or platforms and submitting said relations and compilations to said processor units and memories from which said relations and compilations are computer server-automatically outputted and said individual words, terms, phrases, sentences, 2-dimensional and 3-dimensional representations of body parts, illustrations, figurines, graphics and related word and term headers or headings are related to individual unique SQL keys and compiled in and among said SQL tables in said SQL databases;
individual unique SQL units in and among SQL tables in said SQL databases in and manage by said SQL Server created in said processor units and memories coupled to said SQL Server and said innovative computer programs and software and stored procedures for creating and generating said individual unique SQL units in and among said in and among SQL tables in said SQL databases;
relations or associations of individual SQL keys and related words, terms, phrases and sentences in and among said individual SQL units in and among SQL tables in said SQL databases;
relations and compilations of individual unique words, terms, phrases or sentences representing individual unique chief complaints related individual unique PQRST, individual unique signs related individual unique PQRST, individual unique symptoms and related individual unique PQRST, individual unique reviews of systems and related and individual unique PQRST, individual unique physical examinations or findings, individual unique laboratory results and data related to individual SQL keys which are related to individual unique SQL keys related to individual unique anatomical locations, macroscopic anatomy, microscopic anatomy, individual body sites, organ systems, DNA and RNA and biological and disease processes and events and individual unique SQL keys related to individual diagnoses and individual syndromes related to individual SQL keys related to information and data on individual physicians and patients in and among SQL tables in said SQL databases;
a plurality of interactive related adaptable electronic Plasmids comprise adaptable relations and compilations of interactive individual unique words, terms, phrases and sentences representing individual unique chief complaints and related individual unique PQRST, individual unique signs, and related individual unique PQRST individual unique symptoms and related individual unique PQRST, individual unique reviews of systems and related individual unique PQRST, individual unique physical examinations or findings and data, individual unique laboratory tests and results and data, DNA and RNA and biological and disease processes and events and related to 2-dimensional and 3-dimensional representations of body parts, illustrations, figurines, graphics and related word and term headers or headings and in said viewing screens of said devices and/or platforms;
degrees of preponderance of relations or associations of and among said individual unique words, terms, phrases and/or sentences represented by numbers assigned to said degrees of preponderance of relations or associations of and among said individual unique words, terms, phrases and/or sentences in and among said SQL tables in said SQL databases;
adaptable positions, orders or ranking of appearances of said interactive said individual unique words, terms, phrases and sentences in and among said plurality of said related interactive electronic Plasmids in said viewing screens based on numerical degrees of preponderance of said relations or associations of and among said individual unique words, terms, phrases and/or sentences in and among SQL tables in said SQL databases;
interactive unique patients' words, terms, phrases or sentences related to word and term headers or headings, 2-dimensional and 3-dimensional representations of body parts, illustrations, figurines, graphics, highlights, contrasts, macroscopic anatomy, microscopic anatomy, individual body sites, organ systems, DNA and RNA and/or biological and disease processes and events in alphabetical and logically prevalent orders or ranks in said viewing screens and/or platforms based on said numerical degrees of said prevalence of uses or preponderance of uses of said individual words, terms, phrases and sentences related to diseases, illnesses and disorders and related to said individual body sites, parts, illustrations, figurines, graphics by and among said people in said SQL tables in said SQL databases;
numerical degrees of relations or associations of said individual patients' words, terms, phrases and sentences and said individual unique words, terms, phrases or sentences in and among SQL tables in said SQL databases;
relations and compilations of individual unique words, terms, phrases and sentences in and among said plurality of said related interactive electronic Plasmids in said viewing screens generated and submitted to said processor units and memories by, among and/or between said people related to individual unique words, terms, phrases and/or sentences and related to numerical degrees of said relations or associations of individual unique words, terms, phrases and/or sentences in and among SQL tables in said SQL databases and individual outcomes of said relations and compilations related to appropriate individual SQL units in said processor units and memories and in and among SQL tables in said SQL databases;
relations and compilations of individual patients' words, terms, phrases and sentences in and among said plurality of said related interactive electronic templates in said viewing screens generated and submitted to said processor units and memories by, among and/or between said people and individual outcomes of said relations and compilations related to patients' words, terms, phrases and sentences related to numerical degrees of preponderance or prevalence of uses of said individual patients' words, terms, phrases and sentences related to said chief complaints, signs and symptoms and related PQRST and related individual anatomical sites in said SQL tables in said SQL databases and related individual SQL keys related to individual SQL keys related to individual unique words, terms, phrases and sentences related to appropriate individual SQL units in said processor units and memories and in and among SQL tables in said SQL databases;
the networks for assisting the diagnosing, managing and controlling diseases, illnesses and disorders and related developments, courses, recurrences, progressions and preventions by, for and/or among people;
the networks for relating individual diagnoses related to individual or individual groups of related and/or unrelated diseases, disorders and illnesses and related health and health-care services and managements of said diseases, illnesses and disorders and related information and data by, between and among people in diverse settings, circumstances and locations;
the networks for transforming random or chaotic processes for encountering of, between and among people seeking information and data on health, health-care, diseases, disorders and illness and related health and health-care services and managements of diseases, illnesses and disorders and related information and data on physicians into computer-servers ordered, guided and/or efficient encounters of, between and among said people; and
the networks for dispensing, disseminating and sharing said information and data on diagnoses, diseases and illnesses and efficient and optimal managements, preventions and controls of said diseases, illnesses and disorders and related health-care services and cares by, among and between said people.

2. In the networks according to claim 1 wherein said networks for assisting the diagnosing, managing and controlling diseases, illnesses and disorders and related developments, courses, recurrences, progressions and preventions by, for and/or among people comprises:
said individual unique SQL units;
said relations or associations of individual SQL keys and related words, terms, phrases and sentences in and among said individual SQL units;
said relations and compilations of individual unique words, terms, phrases and sentences in and among said plurality of said related interactive electronic Plasmids in said viewing screens generated and submitted to said processor units and memories by, among and/or between said people related to individual unique words, terms, phrases and/or sentences and related to numerical degrees of said relations or associations of individual unique words, terms, phrases and/or sentences in and among SQL tables in said SQL databases and individual outcomes of said relations and compilations related to appropriate individual SQL units in said processor units and memories and in and among SQL tables in said SQL databases; and
said relations and compilations of individual patients' words, terms, phrases and sentences in and among said plurality of said related interactive electronic templates in said viewing screens generated and submitted to said processor units and memories by, among and/or between said people and individual outcomes of said relations and compilations related to patients' words, terms, phrases and sentences related to numerical degrees of preponderance or prevalence of uses of said individual patients' words, terms, phrases and sentences related to said chief complaints, signs and symptoms and related PQRST and related individual anatomical sites in said SQL tables in said SQL databases and related individual SQL keys related to individual SQL keys related to individual unique words, terms, phrases and sentences related to appropriate individual SQL units in said processor units and memories and in and among SQL tables in said SQL databases.

3. In the networks according to claim 1 wherein said networks for transforming random or chaotic processes for encountering of, between and among people seeking information and data on health, health-care, diseases, disorders and illness and related health and health-care services and managements of diseases, illnesses and disorders and related information and data on physicians into computer-servers ordered, guided and/or efficient encounters of, between and among said people comprises:
said individual unique SQL units;
said relations or associations of individual SQL keys and related words, terms, phrases and sentences in and among said individual SQL units;
said relations and compilations of individual unique words, terms, phrases and sentences in and among said plurality of said related interactive electronic Plasmids in said viewing screens generated and submitted to said processor units and memories by, among and/or between said people related to individual unique words, terms, phrases and/or sentences and related to numerical degrees of said relations or associations of individual unique words, terms, phrases and/or sentences in and among SQL tables in said SQL databases and individual outcomes of said relations and compilations related to appropriate individual SQL units in said processor units and memories and in and among SQL tables in said SQL databases; and
said relations and compilations of individual patients' words, terms, phrases and sentences in and among said plurality of said related interactive electronic templates in said viewing screens generated and submitted to said processor units and memories by, among and/or between said people and individual outcomes of said relations and compilations related to patients' words, terms, phrases and sentences related to numerical degrees of preponderance or prevalence of uses of said individual patients' words, terms, phrases and sentences related to said chief complaints, signs and symptoms and related PQRST and related individual anatomical sites in said SQL tables in said SQL databases and related individual SQL keys related to individual SQL keys related to individual unique words, terms, phrases and sentences related to appropriate individual SQL units in said processor units and memories and in and among SQL tables in said SQL databases.

4. In the networks according to claim 1 wherein said networks dispensing, disseminating and sharing said information and data on diagnoses, diseases and illnesses and efficient and optimal managements, preventions and controls of said diseases, illnesses and disorders and related health-care services and cares by, among and between said people comprises:
said individual unique SQL units;
said relations or associations of individual SQL keys and related words, terms, phrases and sentences in and among said individual SQL units;
said relations and compilations of individual unique words, terms, phrases and sentences in and among said plurality of said related interactive electronic Plasmids in said viewing screens generated and submitted to said processor units and memories by, among and/or between said people related to individual unique words, terms, phrases and/or sentences and related to numerical degrees of said relations or associations of individual unique words, terms, phrases and/or sentences in and among SQL tables in said SQL databases and individual outcomes of said relations and compilations related to appropriate individual SQL units in said processor units and memories and in and among SQL tables in said SQL databases; and
said relations and compilations of individual patients' words, terms, phrases and sentences in and among said plurality of said related interactive electronic templates in said viewing screens generated and submitted to said processor units and memories by, among and/or between said people and individual outcomes of said relations and compilations related to patients' words, terms, phrases and sentences related to numerical degrees of preponderance or prevalence of uses of said individual patients' words, terms, phrases and sentences related to said chief complaints, signs and symptoms and related PQRST and related individual anatomical sites in said SQL tables in said SQL databases and related individual SQL keys related to individual SQL keys related to individual unique words, terms, phrases and sentences related to appropriate individual SQL units in said processor units and memories and in and among SQL tables in said SQL databases.

5. In the networks of patients and physicians and computer servers, teleconferencing platforms including video conferencing henceforth platforms and computers, laptops, hand-held and mobile communication devices and equipment for accessing and interacting with said servers and platforms henceforth devices being used by patients and physicians networked to said servers adaptable to technologically push, pull, forward, disseminate, share and/or stream relational information and data on health and health-care, including laboratory-generated laboratory data, related to, created and generated and submitted by said people to the processor units and memories of said computer servers and compiled and related as said relational information and data in and among SQL tables in SQL databases in and manage by a SQL server in said computer servers wherein said adaptable relational information and data are displayed on the viewing screens and interactive with, among and between and according to individual physicians, individual patients, individual groups of physicians and individual groups of physicians and patients in diverse and different settings, circumstances and locations henceforth people for computer servers-guiding and assisting in diagnosing, managing, treating, preventing and controlling diseases, illnesses and disorders and related developments, courses, risks, recurrences, progressions and preventions for, by, among and between said people using said networks, a method for said networks automatically transforming random or chaotic processes for encountering of, between and among physicians and people seeking information and data on health, health-care, diseases, disorders and illness and related health and health-care services and managements of diseases, illnesses and disorders into computer-servers ordered, guided and/or efficient encounters of, between and among patients and physicians and efficient and optimal managements of said diseases, illnesses and disorders, and dispensations and disseminations and sharing of said relational information and data and services of, for, between and among patients and physicians, in diverse and different settings, circumstances and locations, using computers, laptops, hand-held and mobile devices and equipment henceforth devices for networking with and accessing said servers and related teleconferencing platforms including video conferencing networked to said servers henceforth platforms in said networks for instantly and continually communicating, disseminating, sharing and/or technologically streaming relational information and data on diagnoses, diseases and illnesses and managing and preventing said diseases, illnesses and disorders for, among and between patients and physicians comprises:
a process for operating said networks comprising said functioning and operating computer servers, devices and platforms being used by and among said people;
a process for the innovative computer programs and software and stored procedures to instruct, command and cause said processor units and memories to repetitively and continually transform random or chaotic events for encountering of, between and among said people seeking information and data on health, health-care, diseases, disorders and illness and related health and health-care services and managements of diseases, illnesses and disorders into ordered, guided and/or efficient encounters and efficient and optimal managements of said diseases, illnesses and disorders, and dispensations and disseminations of said information and data and services of, for, between and among people in diverse and different settings, circumstances and locations and for instantly and continually communicating, disseminating and/or technologically pushing, pulling, streaming and sharing said relational information and data on diagnoses, diseases and illnesses and managing and preventing said diseases, illnesses and disorders for, among and between people in said networks;
a process for implementing said innovative computer program and software and stored procedures for creating and generating relations and compilations of words, terms, phrases, sentences, 2-dimensional and 3-dimensional representations of body parts, illustrations, figurines, graphics and related word and term headers or headings representing and related to categories of diagnoses and/or syndromes, differential diagnoses and related chief complaints, signs and symptoms and related PQRST, reviews of systems and related PQRST, physical examinations or findings, laboratory results and data, anatomical locations, anatomical sites and organ systems, diagnoses, syndromes, genetics, etiologies, causes, sources and pathologic basis of diseases and illnesses, family histories, travel histories, treatments, surgeries, procedures, assessments and plans, medications, recommendations, advices, referrals and follow-ups and related adjectives and variables and synonyms, acronyms and graphics and related qualifying information and data use by physicians of about 85 medical and surgical specialties and practices in computer files by physicians using said devices and/or platforms and submitting said relations and compilations to said processor units and memories from which said relations and compilations are computer server-automatically outputted and related by individual unique SQL keys and compiled, according to said innovative computer programs and software and stored procedures, in and among said SQL tables in said SQL databases;
a process for said innovative computer program and software and stored procedures to cause said processor units and memories to create and generate individual unique SQL units in and among said SQL tables in said SQL databases by said processor units and memories analyzing, checking, scanning and matching said relations and compilations of said words, terms, phrases, sentences, 2-dimensional and 3-dimensional representations of body parts, illustrations, figurines, graphics and related word and term headers or headings in and among SQL tables;
a process for said innovative computer program and software and stored procedures to cause said processor units and memories to analyze and relate individual SQL keys in and among said individual unique SQL units in and among said SQL tables in said SQL databases to create and generate relations and compilations of related SQL keys in and among said individual SQL units in and among SQL tables in said SQL databases;
a process for said innovative computer program and software and stored procedures to cause said processor units and memories to create and generate individual unique words, terms, phrases or sentences representing individual unique chief complaints, individual unique signs, individual unique symptoms and related individual unique PQRST, individual unique reviews of systems and related and individual unique PQRST, individual unique physical examinations or findings, individual unique laboratory results and data related to individual SQL keys which are related to individual unique SQL keys related to individual unique anatomical locations, macroscopic anatomy, microscopic anatomy, individual body sites, organ systems, DNA and RNA and biological and disease processes and events and individual unique keys related to individual diagnoses and individual syndromes in and among SQL tables in said SQL databases;
a process for said innovative computer program and software and stored procedures and said processor units and memories causing repetitive retrievals and displays in said viewing screens adaptable compilations of said interactive said unique words, terms, phrases or sentences related to individual interactive diagnoses or individual syndromes, individual groups of interactive diagnoses and/or individual groups of interactive diagnoses and/or interactive syndromes upon prompting by said devices and/or platforms being used by said people;
a process for said innovative computer program and software and stored procedures and to cause said processor units and memories to relate and compile relations and compilations of interactive said unique words, terms, phrases or sentences related to individual interactive diagnoses or individual syndromes, individual groups of interactive diagnoses and/or individual groups of interactive diagnoses and/or interactive syndromes by and among and submitted to said processor units and memories by physicians;
a process for said innovative computer program and software and stored procedures to cause said processor units and memories to analyze, calculate and tally the frequencies, degrees, preponderance or prevalence in said SQL tables in said SQL databases of individual relations or associations of and among related said unique words, terms, phrases or sentences related to individual unique anatomical locations, macroscopic anatomy, microscopic anatomy, individual body sites, organ systems, DNA and RNA and biological and disease processes and events in said relations and compilations created and generated by, among and/or between physicians using said devices and/or platforms and tabulated as numerical degrees of said relations or associations in said SQL tables in said SQL databases;
a process for said innovative computer program and software and stored procedures and said processor units and memories to repetitively create, generate and display a plurality of interactive related electronic Plasmids in said viewing screens of said devices and/or platforms being used by said people in said networks;
a process for said innovative computer program and software and stored procedures and said processor units and memories to repetitively create and generate a means for limiting accesses of said interactive electronic Plasmids among said people using said devices and/or platforms;
a process for said innovative computer program and software and stored procedures and said processor units and memories to repetitively retrieve and display said interactive said unique words, terms, phrases or sentences in orders or ranks based on said numerical degrees of said relations or associations of interactive said unique words, terms, phrases or sentences in and among said plurality of said related interactive electronic Plasmids comprising said related interactive said unique words, terms, phrases or sentences in said viewing screens and/or platforms;
a process for said innovative computer program and software and stored procedures to cause said processor units and memories to create and generate individual unique patients' words, terms, phrases or sentences representing individual unique chief complaints, individual unique signs, individual unique symptoms and related individual unique PQRST in English or other languages and 2-dimensional and 3-dimensional representations of body parts, illustrations, figurines, graphics and related word and term headers or headings;
a process for said innovative computer program and software and stored procedures and said processor units and memories causing repetitive retrievals and displays in said viewing screens adaptable compilations of said interactive said unique patients' words, terms, phrases or sentences and 2-dimensional and 3-dimensional representations of body sites, parts, illustrations, figurines, graphics and related word and term headers or headings related to individual diseases, illnesses or disorders upon prompting by said devices and/or platforms being used by said people;
a process for said innovative computer program and software and stored procedures to cause said processor units and memories to create and generate individual relations and compositions of unique patients' words, terms, phrases and/or sentences related to individual anatomical sites related to individual diagnoses and/or syndromes and related diseases, illnesses and disorders and related to individual unique SQL keys in and among SQL tables related to individual unique SQL keys related to said individual relations and compositions of said individual unique patients' words, terms, phrases and/or sentences and individual unique words, terms, phrases and/or sentences and related said numerical degrees and therefore related diagnoses and related information and data related to individual physicians related to individual unique SQL keys in and among SQL tables in said SQL databases in and manage by said SQL Server;
a process for said innovative computer program and software and stored procedures to cause said processor units and memories to create and generate and display individual unique interactive patients' words, terms, phrases or sentences in the viewing screens; and, consequently,
a process for said innovative computer program and software and stored procedures to cause said processor units and memories analyze, calculate and tally the frequencies, degrees, preponderance or prevalence of individual relations or associations of said patients' words, terms, phrases and sentences related to individual body sites, parts, illustrations, figurines, graphics in said patients' description of diseases, illnesses and disorders used by and among said patients using said devices and/or platforms and tabulated as numerical degrees of said prevalence of uses or preponderance of uses of said individual words, terms, phrases and sentences related to said individual body sites, parts, illustrations, figurines, graphics in said SQL tables in said SQL databases;
a process for said innovative computer program and software and stored procedures and said processor units and memories causing repetitive retrievals and displays in said viewing screens adaptable compilations of said interactive said unique patients' words, terms, phrases or sentences and 2-dimensional and 3-dimensional representations of body sites, parts, illustrations, figurines, graphics and related word and term headers or headings in orders or ranks numerical degrees of said prevalence of uses or preponderance of uses of said individual words, terms, phrases and sentences related to said individual body sites, parts, illustrations, figurines, graphics in said SQL tables in said SQL databases;
a process for said innovative computer program and software and stored procedures to cause said processor units and memories to create and generate relations and compilations of said patients' unique words, terms, phrases or sentences and related SQL keys and related said numerical degrees of said prevalence with corresponding or related individual unique words, terms, phrases or sentences representing individual unique chief complaints, individual unique signs, individual unique symptoms and related individual unique PQRST, individual unique reviews of systems and related and individual unique PQRST, individual unique physical examinations or findings, individual unique laboratory results and data related to individual SQL keys which are related to individual unique SQL keys related to individual unique anatomical locations, macroscopic anatomy, microscopic anatomy, individual body sites, organ systems, DNA and RNA and biological and disease processes and events and individual unique keys related to individual diagnoses and individual syndromes and related frequencies, degrees, preponderance or prevalence in said SQL tables in said SQL databases of individual relations or associations of and among related said unique words, terms, phrases or sentences in and among SQL tables in said SQL databases;
a process for said innovative computer program and software and stored procedures to repetitively cause said processor units and memories to automatically scan, analyze and match said words, terms, phrases or sentences created and generated and submitted to processor units and memories by said individual patients using said devices and/or platforms wherein said individual submissions are, first, automatically scan, analyze and match with unique words, terms, phrases or sentences and related SQL keys and related said numerical degrees of said prevalence and, consequently, second, based on said frequencies, degrees, preponderance or prevalence in said SQL tables in said SQL databases of individual relations or associations of and among related said unique words, terms, phrases or sentences, said related individual SQL keys related to individual unique words, terms, phrases or sentences representing individual unique chief complaints, individual unique signs, individual unique symptoms and related individual unique PQRST, individual unique reviews of systems and related and individual unique PQRST, individual unique physical examinations or findings, individual unique laboratory results and data related to individual SQL keys which are related to individual unique SQL keys related to individual unique keys related to individual diagnoses and individual syndromes and related information and data on physicians in and among SQL tables in said SQL databases and individual SQL Units;
a process for said networks assisting the diagnosing, managing and controlling diseases, illnesses and disorders and related risks, developments, courses, recurrences, progressions and preventions by, for and among people using said devices and/or platforms in said networks;
a process for innovative computer programs and software and stored procedures and said processor units and memories to instantly influence adaptable clinical decisions and consequent actions related to said adaptable displays of said relations and compositions in and among said adaptable Plasmids and numbers of displayed Plasmids of said of individual physicians or individual groups of physicians by generating and displaying individual interactive panels displaying instant, adaptable and interactive information and data on diagnosis, individual diagnoses, individual syndromes, individual groups of diagnoses and/or syndromes and related said information and data on health, health-care services and diseases, disorders and illnesses and related information and data on individual physicians and/or individual groups of physicians in adaptable interactive linked electronic templates, pop-up and drop-downs in said viewing screens;
a process for networking said people in said networks for relating individual diagnoses related to individual or individual groups of related and/or unrelated diseases, disorders and illnesses and related health and health-care services and managements of said diseases, illnesses and disorders and related information and data by, between and among people in diverse settings, circumstances and locations;
a process for said networks transforming random or chaotic processes for encountering of, between and among people seeking information and data on health, health-care, diseases, disorders and illness and related health and health-care services and managements of diseases, illnesses and disorders and related information and data on physicians into computer-servers ordered, guided and/or efficient encounters of, between and among said people; and
a process for said networks dispensing, disseminating and sharing said information and data on diagnoses, diseases and illnesses and efficient and optimal managements, preventions and controls of said diseases, illnesses and disorders and related health-care services and cares by, among and between said people.

6. The method according to claim 5 wherein said process for said innovative computer program and software and stored procedures to create and generate individual unique SQL units in and among said SQL tables in said SQL databases by said processor units and memories analyzing, checking, scanning and matching said relations and compilations of said words, terms, phrases, sentences, 2-dimensional and 3-dimensional representations of body parts, illustrations, figurines, graphics and related word and term headers or headings in and among said SQL tables comprises:
a process for implementing said innovative computer program and software and stored procedures means for creating and generating relations and compilations of words, terms, phrases, sentences, 2-dimensional and 3-dimensional representations of body parts, illustrations, figurines, graphics and related word and term headers or headings representing diagnoses and/or syndromes, differential diagnoses and related chief complaints, signs and symptoms and related PQRST, reviews of systems and related PQRST, physical examinations or findings, laboratory results and data, anatomical locations, anatomical sites and organ systems, diagnoses, syndromes, genetics, etiologies, causes, sources and pathologic basis of diseases and illnesses, family histories, travel histories, treatments, surgeries, procedures, assessments and plans, medications, recommendations, advices, referrals and follow-ups and related adjectives and variables and synonyms, acronyms and graphics and related information and data on individual physicians or individual groups of physicians and related qualifying information and data use by physicians of about 85 medical and surgical specialties and practices in computer files by physicians using said devices and/or platforms and submitting said relations and compilations to said processor units and memories from which said relations and compilations are computer server-automatically outputted and said individual words, terms, phrases, sentences, 2-dimensional and 3-dimensional representations of body parts, illustrations, figurines, graphics and related word and term headers or headings are related to individual unique SQL keys and compiled in and among said SQL tables in said SQL databases; and
a process for said innovative computer program and software and stored procedures to cause said processor units and memories to create and generate from said relations and compilations individual unique SQL units each of which comprises a unique SQL relation and compilation of a unique diagnosis or syndrome related to a unique SQL key to which appropriately related individual unique SQL keys related to said individual words, terms, phrases, sentences, 2-dimensional and 3-dimensional representations of body parts, illustrations, figurines, graphics and related word and term headers or headings related to said information and data on said individual physicians and related individual SQL keys related to said information and data health, health-care and health-care services, diseases, illnesses and disorders in and among said SQL tables in said SQL databases.

7. The process for said innovative computer program and software and stored procedures to cause said processor units and memories to create and generate from said relations and compilations individual unique SQL units each of which comprises a unique SQL relation and compilation of a unique diagnosis or syndrome related to a unique SQL key to which appropriately related individual unique SQL keys related to said individual words, terms, phrases, sentences, 2-dimensional and 3-dimensional representations of body parts, illustrations, figurines, graphics and related word and term headers or headings related to said information and data on said individual physicians and related individual SQL keys related to said information and data health, health-care and health-care services, diseases, illnesses and disorders in and among said SQL tables in said SQL databases according to claim 6 comprises:
a process for said innovative computer program and software and stored procedures to cause said processor units and memories to repetitively scan and check said individual words, terms, phrases and sentences representing individual diagnoses and individual syndromes and related differential diagnoses and related chief complaints, signs and symptoms and related PQRST, reviews of systems and related PQRST, physical examinations or findings, laboratory results and data, anatomical locations, anatomical sites and organ systems, diagnoses, syndromes, genetics, etiologies, causes, sources and pathologic basis of diseases and illnesses, family histories, travel histories, treatments, surgeries, procedures, assessments and plans, medications, recommendations, advices, referrals and follow-ups and related adjectives and variables and synonyms, acronyms and scan, match, analyze and remove redundant duplicates or repeats, doubles related to individual diagnoses or individual syndromes and related said words, terms, phrases and sentences in said individual SQL units in and among said SQL tables in said SQL databases; and, consequently,
a process for said innovative computer program and software and stored procedures to cause said processor units and memories to:
i. assign and relate said individual SQL keys related to said individual words, terms, phrases and sentences representing said individual diagnoses or individual syndromes representing or relating to said individual diagnoses or syndromes, respectively, related to said individual SQL keys in said individual SQL units in and among said SQL tables in said SQL databases; and
ii. assign and relate said individual SQL keys related to said individual words, terms, phrases and sentences representing differential diagnoses and related chief complaints, signs and symptoms and related PQRST, reviews of systems and related PQRST, physical examinations or findings, laboratory results and data, anatomical locations, anatomical sites and organ systems, diagnoses, syndromes, genetics, etiologies, causes, sources and pathologic basis of diseases and illnesses, family histories, travel histories, treatments, surgeries, procedures, assessments and plans, medications, recommendations, advices, referrals and follow-ups and related adjectives and variables and synonyms, acronyms and related information and data on said individual physicians related to said individual SQL keys related to said individual diagnoses, syndromes, diseases, illnesses and disorders to said individual words, terms, phrases and sentences in said individual SQL units in and among said SQL tables in said SQL databases.

8. The method according to claim 5 wherein said process for said innovative computer program and software and stored procedures and said processor units and memories to repetitively create, generate and display a plurality of interactive related electronic Plasmids in said viewing screens of said devices and/or platforms being used by said people in said networks comprises:
a process for said innovative computer program and software and stored procedures to cause said processor units and memories to create and generate individual unique words, terms, phrases or sentences representing individual unique chief complaints, individual unique signs, individual unique symptoms and related individual unique PQRST, individual unique reviews of systems and related individual unique PQRST, individual unique physical examinations or findings, individual unique laboratory tests and results and data, DNA and RNA and biological and disease processes and events related to individual SQL keys related to individual unique SQL keys related to individual unique anatomical locations or sites, macroscopic anatomy, microscopic anatomy, individual body sites, organ systems, DNA and RNA and biological and disease processes and events and individual unique keys related to individual diagnoses and individual syndromes in processor units and memories and in and among said SQL tables in said SQL databases comprising:
said process for implementing said innovative computer program and software and stored procedures for creating and generating said relations and compilations of said words, terms, phrases, sentences, 2-dimensional and 3-dimensional representations of body parts, illustrations, figurines, graphics and related word and term headers or headings use by physicians of about 85 medical and surgical specialties and practices in and among said SQL tables in said SQL databases;
said process for said innovative computer program and software and stored procedures to cause said processor units and memories to create and generate said individual unique SQL units in and among said SQL tables in said SQL databases;
a process for said innovative computer program and software and stored procedures to cause said processor units and memories to create and generate said individual unique words, terms, phrases or sentences from scanning, analyzing and matching said words, terms, phrases or sentences and/or said individual unique SQL units to create said individual unique words, terms, phrases or sentences related to individual SQL keys, without redundant duplicates or repeats, doubles, in and among said SQL tables in SQL databases;
a process for said innovative computer program and software and stored procedures to cause said processor units and memories to retrieve, relate and display tens of thousands unique words, terms, phrases or sentences and said individual unique anatomical locations, macroscopic anatomy, microscopic anatomy, individual body sites, organ systems, DNA and RNA and biological and disease processes and events in a plurality of interactive templates wherein said relations and compilations are effected and submitted to said processor units and memories and related to individual SQL keys in and among SQL tables in said SQL databases; and, consequently,
a process for said innovative computer program and software and stored procedures and said processor units and memories to repetitively create and generate and display adaptable said relations and compilations related to individual anatomical locations, macroscopic anatomy, microscopic anatomy, individual body sites, organ systems, DNA and RNA and biological and disease processes and events in said viewing screens upon prompting by, among and between said people;
a process for said innovative computer program and software and stored procedures to cause said processor units and memories to create and generate individual unique relations and compilations of related individual SQL keys related to said individual unique words, terms, phrases or sentences in and among said Plasmids in and among in and among SQL tables in said SQL databases upon submissions of relations and compilations of said individual unique words, terms, phrases or sentences to said processor units and memories by physicians using said devices and/or platforms;
a process for said innovative computer program and software and stored procedures to cause said processor units and memories to analyze, calculate and tally the frequencies, degrees, preponderance or prevalence in said SQL tables in said SQL databases of individual relations or associations of and among related said unique words, terms, phrases or sentences related to individual unique anatomical locations, macroscopic anatomy, microscopic anatomy, individual body sites, organ systems, DNA and RNA and biological and disease processes and events in said relations and compilations generated by, among and/or between said people using said devices and/or platforms and tabulated as numerical degrees of said relations or associations in said SQL tables in said SQL databases; and, consequently,
a process for repetitively retrieving and displaying said interactive said unique words, terms, phrases or sentences in preponderance, predominant orders or ranks based on said numerical degrees of said relations or associations of interactive said unique words, terms, phrases or sentences in and among individual said interactive related electronic Plasmids in said viewing screens and/or platforms;
a process for relating and compiling said interactive said unique words, terms, phrases or sentences in and among individual said interactive electronic Plasmids in said viewing screens and/or platforms by, among and/or between said people to effect and achieve:
i. said process for networking physicians in said networks for relating individual diagnoses related to individual or individual groups of related diseases, disorders and illnesses and related health and health-care services and managements of said diseases, illnesses and disorders and related information and data by, between and among physicians;
ii. said process for said networks dispensing, disseminating and sharing said information and data on diagnoses, diseases and illnesses and efficient and optimal managements, preventions and controls of said diseases, illnesses and disorders and related health-care services and cares by, among and between said people; and
iii. said process for said networks transforming random or chaotic processes for encountering of, between and among people seeking information and data on health, health-care, diseases, disorders and illness and related health and health-care services and managements of diseases, illnesses and disorders and related information and data on physicians into computer-servers ordered, guided and/or efficient encounters of, between and among said people in diverse settings, circumstances and locations.

9. The method according to claim 5 wherein said process for said networks assisting the diagnosing, managing and controlling diseases, illnesses and disorders and related risks, developments, courses, recurrences, progressions and preventions by, for and among people using said devices and/or platforms in said networks comprises:
said process for said innovative computer program and software and stored procedures and processor units and memories to repetitively create, generate and display a plurality of related interactive electronic Plasmids comprising individual interactive related unique words, terms, phrases or sentences in said viewing screens prompted by said devices and/or platforms;
said process of said innovative computer program and software and stored procedures and processor units and memories to repetitively enable and effect successive or sequential selections, clicks and generations of relations and compilations of said individual interactive unique words, terms, phrases or sentences in and among said interactive electronic Plasmids in said viewing screens by and among said people;
a process for innovative computer programs and software and stored procedures and said processor units and memories to repetitively generate and display individual panels for logging and displaying said relations and compilations in said viewing screens with successive clicking of said individual unique words, terms, phrases or sentences in said interactive related Plasmids by and among said people; and instantly consequent to and accompanying said processes;
a process for innovative computer programs and software and stored procedures and said processor units and memories to instantly influence adaptable clinical decisions and consequent actions related to said adaptable displays of said relations and compositions in and among said adaptable Plasmids and numbers of displayed Plasmids of said of individual physicians or individual groups of physicians by generating and displaying individual interactive panels displaying instant, adaptable and interactive information and data on diagnosis, individual diagnoses, individual syndromes, individual groups of diagnoses and/or syndromes and related said information and data on health, health-care services and diseases, disorders and illnesses and related information and data on individual physicians and/or individual groups of physicians in adaptable interactive linked electronic templates, pop-up and drop-downs in said viewing screens;
consequent to said successive or sequential selections and clicks, a process for innovative computer programs and software and stored procedures to cause said processor units and memories, responding to said successive or sequential selections and clicks, to sequentially, dynamically and instantly adapting, adjusting and displaying adaptable relations and compilations of said individual unique words, terms, phrases or sentences in and among said Plasmids consequent to said processor units and memories scanning, analyzing and matching with individual SQL units in said processor units and memories and sequentially, dynamically and instantly retrieving and displaying said adaptable relations and compilations in and among said Plasmids including:
a process for innovative computer programs and software and stored procedures to cause said processor units and memories to retrieve, order and display said relations and compilations of interactive said unique words, terms, phrases or sentences as individual hierarchies of adaptable positions or ranking of said unique words, terms, phrases or sentences in and among individual said interactive related electronic Plasmids and preponderance, predominant orders or ranks or positions of said Plasmids in said viewing screens based on said numerical degrees of said relations or associations of and among said individual unique words, terms, phrases or sentences related to appropriate individual SQL units and individual diagnoses and related individual SQL keys in and among SQL tables in said SQL databases;
a process for viewing, selecting and clicking individual relations and compositions of interactive said unique words, terms, phrases or sentences in and among individual said interactive related electronic Plasmids and submitting said individual relations and compilations to said processor units and memories by said people; and, consequently,
a process for said innovative computer program and software and stored procedures to cause said processor units and memories to repetitively analyze, scan and match said submissions with individual SQL units in said processor units and memories for said processor units and memories to generate and display related individual outcomes comprise information and data on diagnosis, individual diagnoses, individual syndromes, individual groups of diagnoses and/or syndromes and related said information and data on health, health-care services and diseases, disorders and illnesses and related information and data on individual physicians and/or individual groups of physicians in adaptable interactive linked electronic templates, pop-up and drop-downs in said viewing screens; and
a process for said innovative computer program and software and stored procedures to cause said processor units and memories to repetitively analyze, scan and match said submissions with said individual SQL units and related individual SQL keys related to words, terms, phrases and sentences in and among individual appropriate SQL units in said processor units and memories for said processor units and memories to generate and display related individual outcomes comprise information and data on diagnosis, individual diagnoses, individual syndromes, individual groups of diagnoses and/or syndromes and related said information and data on health, health-care services and diseases, disorders and illnesses and related information and data on individual physicians and/or individual groups of physicians in adaptable interactive linked electronic templates, pop-up and drop-downs in said viewing screens.

10. The method according to claim 5 wherein said process for innovative computer programs and software and stored procedures and said processor units and memories to instantly influence adaptable clinical decisions and consequent actions related to said adaptable displays of said relations and compositions in and among said adaptable Plasmids and numbers of displayed Plasmids of said of individual physicians or individual groups of physicians by generating and displaying individual interactive panels displaying instant, adaptable and interactive information and data on diagnosis, individual diagnoses, individual syndromes, individual groups of diagnoses and/or syndromes and related said information and data on health, health-care services and diseases, disorders and illnesses and related information and data on individual physicians and/or individual groups of physicians in adaptable interactive linked electronic templates, pop-up and drop-downs in said viewing screens comprises:
a process for said innovative computer program and software and stored procedures to cause said processor units and memories to create and generate said relations and compilations of individual unique words, terms, phrases and sentences—related to individual unique anatomical locations, macroscopic anatomy, microscopic anatomy, individual body sites, organ systems, DNA and RNA and biological and disease processes and events in said relations and compilations—selected and clicked within and among said plurality of said related interactive electronic Plasmids in said viewing screens by and submitted to said processor units and memories by, among and/or between physicians wherein said individual relations and compilations are analyzed, scanned and matched with same or similar relations and compilations to which numerical frequencies or degrees of said prevalence or preponderance of relations or associations of and among said individual unique words, terms, phrases and/or sentences and said SQL Units in and among SQL tables in said SQL databases are calculated, tallied and assigned by said processor units and memories;
said process for said innovative computer program and software and stored procedures to cause said processor units and memories to apply said individual unique SQL units for analyzing, checking, scanning and matching said submissions with said individual unique words, terms, phrases and/or sentences and said SQL Units; and, consequently,
a process for innovative computer programs and software and stored procedures to cause said processor units and memories to sequentially and dynamically adapting, adjusting and responding, consequent to said process for analyzing, scanning and matching said individual submissions with individual SQL units, by retrieving and displaying adaptable orders, ranking or relative positions of said related individual unique words, terms, phrases and sentences in said adaptable relations and compilations in and among said related interactive electronic Plasmids;
said process for innovative computer programs and software and stored procedures to cause said processor units and memories to retrieve and display said adaptable relations and compilations of interactive said unique words, terms, phrases or sentences as individual hierarchies of adaptable relative positions or ranking of related said individual unique words, terms, phrases or sentences in and among individual said interactive related electronic Plasmids and preponderance, predominant orders or ranks or positions of said Plasmids in said viewing screens based on said numerical frequencies or degrees of said prevalence or preponderance of relations or associations of and among said individual unique words, terms, phrases or sentences in and among SQL tables in said SQL databases.

11. The method according to claim 5 wherein said process for said innovative computer programs and software to cause said processor units and memories to computer servers automatically use and apply said SQL relations and compilations of said words, terms, phrases and sentences in and among said SQL tables in said SQL databases in said processor units and memories to enable any persons, in diverse circumstances and locations, with certain adequate knowledge or skills of said relations and compilations for rapidly accessing and interacting with and using said Plasmids to obtain said outcomes comprises:
a process for said innovative computer program and software and stored procedures to cause said processor units and memories to repetitively create and generate and display a plurality of adaptable interactive signs and symptoms or related said categories and related diagnoses, in and among said SQL tables, displayed in said viewing screens to said individual physicians or individual groups of physicians;
a process for matching said plurality of adaptable interactive signs and symptoms or related said categories and related diagnoses and submitting said chosen associations or choices to said processor units and memories by said individual physicians or individual groups of physicians wherein said individual chosen associations or choices are scanned, analyzed and matched with said individual SQL units for correct and incorrect associations to result in consequent computer server-automatic grants or denials of accesses to said Plasmids to said individual physicians or individual groups of physicians; and if accesses are granted, consequently,
a process for individual physicians or individual groups of physicians to rapidly and instantly accessing and interacting with and using said Plasmids by, among and between physicians or individual groups of physicians using said devices and/or platforms in said networks.

12. The method according to claim 5 wherein said process for said innovative computer program and software and stored procedures to cause said processor units and memories to create and generate and display individual unique interactive patients' words, terms, phrases or sentences in the viewing screens comprises:
a process for said innovative computer program and software and stored procedures and said processor units and memories to retrieve and display individual adaptable interactive linked electronic templates, pop-ups and drop-downs for keyboarding relevant said words, terms, phrases, sentences in English or other languages representing chief complaints, signs and symptoms and related PQRST, family histories, travel histories, treatments, surgeries, procedures, assessments and plans, medications, recommendations, advices, referrals and follow-ups and related adjectives and variables and synonyms related to 2-dimensional and 3-dimensional representations of body parts, illustrations, figurines, graphics, highlights, contrasts, representing the macroscopic anatomy, microscopic anatomy, individual body sites, organ systems, DNA and RNA and/or biological and disease processes and events in said viewing screens and submitting selections and compilations of said keyboarded by said individual patients to said processor units and memories;
a process for said innovative computer program and software and stored procedures to cause said processor units and memories to repetitively scan, check, analyze and match said individual words, terms, phrases and sentences to remove redundant duplicates or repeats, doubles in and among SQL tables in said SQL databases; and, consequently,
a process for said innovative computer program and software and stored procedures to cause said processor units and memories analyze, calculate and tally the frequencies, degrees, preponderance or prevalence of individual relations or associations of said patients' words, terms, phrases and sentences related to individual body sites, parts, illustrations, figurines, graphics in said patients' description of diseases, illnesses and disorders used by and among said patients using said devices and/or platforms and tabulated as numerical degrees of said prevalence of uses or preponderance of uses of said individual words, terms, phrases and sentences related to said individual body sites, parts, illustrations, figurines, graphics in said SQL tables in said SQL databases;
a process for said innovative computer program and software and stored procedures and said processor units and memories causing repetitive retrievals and displays in said viewing screens adaptable relations and compilations of said interactive said unique patients' words, terms, phrases or sentences related to word and term headers or headings, 2-dimensional and 3-dimensional representations of body parts, illustrations, figurines, graphics, highlights, contrasts, macroscopic anatomy, microscopic anatomy, individual body sites, organ systems, DNA and RNA and/or biological and disease processes and events in alphabetical and logically prevalent orders or ranks based on said numerical degrees of said prevalence of uses or preponderance of uses of said individual words, terms, phrases and sentences related to said individual body sites, parts, illustrations, figurines, graphics by and among said people in said SQL tables in said SQL databases in said viewing screens and/or platforms;
a process for relating and compiling said interactive said unique words, terms, phrases or sentences in and among said individual related interactive templates, pop-up and drop-down lists in said viewing screens and/or platforms by, among and/or between said people to effect and create:
i. said process for networking physicians in said networks for relating individual diagnoses related to individual or individual groups of related and/or unrelated diseases, disorders and illnesses and related health and health-care services and managements of said diseases, illnesses and disorders and related information and data by, between and among people;
ii. said process for said networks dispensing, disseminating and sharing said information and data on diagnoses, diseases and illnesses and efficient and optimal managements, preventions and controls of said diseases, illnesses and disorders and related health-care services and cares by, among and between said people; and
iii. said process for said networks transforming random or chaotic processes for encountering of, between and among people seeking information and data on health, health-care, diseases, disorders and illness and related health and health-care services and managements of diseases, illnesses and disorders and related information and data on physicians into computer-servers ordered, guided and/or efficient encounters of, between and among said people in diverse settings, circumstances and locations.

13. The process according to claim 12 wherein said process for said innovative computer program and software and stored procedures and said processor units and memories causing repetitive retrievals and displays in said viewing screens adaptable relations and compilations of said interactive said unique patients' words, terms, phrases or sentences related to word and term headers or headings, 2-dimensional and 3-dimensional representations of body parts, illustrations, figurines, graphics, highlights, contrasts, macroscopic anatomy, microscopic anatomy, individual body sites, organ systems, DNA and RNA and/or biological and disease processes and events includes:
a process for said innovative computer program and software and stored procedures to repetitively cause said processor units and memories to automatically scan, analyze and match said words, terms, phrases or sentences created and generated and submitted to said processor units and memories by said individual patients wherein said individual submissions are automatically scanned, analyzed and matched with unique words, terms, phrases or sentences and related SQL keys and
i. numerical degrees of preponderance or prevalence of uses of said individual patients' words, terms, phrases and sentences related to said chief complaints, signs and symptoms and related PQRST and related individual anatomical sites,
ii. numerical degrees of said relations or associations of and among said individual unique words, terms, phrases and/or sentences, and
iii. numerical degrees of preponderance or prevalence of relations or associations of said individual patients' words, terms, phrases and sentences with said individual unique words, terms, phrases or sentences in and among SQL tables in said SQL databases, and, consequently,
automatically scanned, analyzed and matched to related individual SQL keys related to individual unique words, terms, phrases and sentences representing said individual unique chief complaints, individual unique signs, individual unique symptoms and related individual unique PQRST, individual unique reviews of systems and related and individual unique PQRST, individual unique physical examinations or findings, individual unique laboratory results and data and related frequencies, degrees, preponderance or prevalence of individual relations or associations of and among said unique words, terms, phrases and sentences related to individual diagnoses or individual syndromes and related information and data on physicians in and among SQL tables in said SQL databases and individual SQL Units; and, consequently,
a process for said innovative computer program and software and stored procedures to instruct said processor units and memories to create and generate relations and compilations of individual unique words, terms, phrases and sentences related to individual SQL keys related to individual SQL keys related to individual diagnoses, individual syndromes, individual groups of diagnoses and/or syndromes and related said information and data on health, health-care services and diseases, disorders and illnesses and related information and data on individual physicians and/or individual groups of physicians; and, consequently,
a process for said innovative computer program and software and stored procedures and said processor units and memories causing repetitive retrievals and displays in said viewing screens individual clusters, groups and/or relations and compilations of clinically related interactive words, terms, phrases or sentences related to word and term headers or headings in a plurality of individual adaptable interactive linked electronic templates, pop-up and drop-downs related to individual anatomical sites and individual diagnoses and/or syndromes and related diseases, illnesses and disorders and related health and health-care information and data related to individual unique SQL keys in and among SQL tables in said SQL databases in said viewing screens and/or platforms.

14. The method according to claim 5 wherein said process for networking said people in said networks for relating individual diagnoses related to individual or individual groups of related diseases, disorders and illnesses and related health and health-care services and managements of said diseases, illnesses and disorders and related information and data by, between and among people in diverse settings, circumstances and locations comprises:
a plurality of individual adaptable interactive linked electronic templates, pop-ups, drop-downs comprising said interactive relational patients' words, terms, phrases or sentences representing chief complaints, signs and symptoms in English or other languages displayed based on said orders or ranks numerical degrees of preponderance or prevalence of uses of said individual patients' words, terms, phrases and sentences related to said chief complaints, signs and symptoms and related PQRST and related individual anatomical sites by and among said people in and among SQL tables in said SQL databases linked to related to 2-dimensional and 3-dimensional representations of body parts, illustrations, figurines, graphics and related word and term headers or headings in said viewing screens wherein individual relations and compilations of chief complaints, signs and symptoms are created and generated by and among said people and submitted to said processor units and memories using said devices and/or platforms; and, simultaneously,
a process for innovative computer programs and software and stored procedures and said processor units and memories to repetitively generate and display individual panels for logging and displaying said relations and compilations in said viewing screens with successive clicking of said patients' words, terms, phrases or sentences by and among said people;
a process for said innovative computer program and software and stored procedures to cause said processor units and memories to automatically scan, analyze and match said relations and compilations submitted to said processor units and memories wherein said individual submissions are automatically scan, analyze and match with individual unique patients' words, terms, phrases or sentences related to individual SQL keys related to said numerical degrees of said prevalence of uses; and, consequently,
automatically related to appropriate individual SQL keys related to said individual unique words, terms, phrases and sentences representing said individual unique chief complaints and related individual unique PQRST, individual unique signs and related individual unique PQRST, individual unique symptoms and related individual unique PQRST related to numerical degrees of preponderance or prevalence of relations or associations of said individual patients' words, terms, phrases and sentences with said individual unique words, terms, phrases or sentences in and among SQL tables in said SQL databases; and, relationally,
related individual SQL keys related to individual unique reviews of systems and related individual unique PQRST, individual unique physical examinations or findings, individual unique laboratory results and data and related individual SQL keys related to individual diagnoses and individual syndromes and related information and data on physicians and related said numerical frequencies or degrees of preponderance or prevalence of individual relations or associations of and among said individual unique words, terms, phrases and sentences represented by numbers assigned to said degrees of preponderance of relations or associations of and among said individual unique words, terms, phrases and/or sentences in and among said SQL tables in said SQL databases;
a process for said innovative computer program and software and stored procedures to cause said processor units and memories to automatically scan, analyze and match said individual unique words, terms, phrases and sentences with said individual unique SQL units; and
a process for said innovative computer program and software and stored procedures to cause said processor units and memories to automatically scan, analyze and match said individual unique words, terms, phrases and sentences with said individual unique SQL units and relations or associations of individual SQL keys and related words, terms, phrases and sentences in and among said individual SQL units; and, consequently,
a process for said innovative computer program and software and stored procedures to cause said processor units and memories to create and generate individual outcomes of said computer servers-automatic scans, analyses, matches, comprising information and data on diagnosis, individual diagnoses, individual syndromes, individual groups of diagnoses and/or syndromes and related said information and data on health, health-care services and diseases, disorders and illnesses and related information and data on individual physicians and/or individual groups of physicians in a plurality of individual adaptable interactive linked electronic templates, pop-up and drop-downs in said viewing screens or means for disseminating and receiving said information and data and, consequently,
computer server repetitively, automatically and instantly communicating, disseminating, sharing and/or technologically pushing, pulling, sharing and/or streaming said outcomes in said networks for instant or timed interactions by and among said people for diagnosing, managing and coordinating treatments, cares, preventions and controls of diseases, disorders and illnesses and related risks, developments, courses, recurrences, progressions for, by and among said people in diverse and different settings, circumstances and locations and a search function in said viewing screens.

15. The process for said innovative computer programs and software and stored procedures to cause said processor units and memories to automatically scan, analyze and match said individual unique words, terms, phrases and sentences with said individual unique SQL units according to claim 14 comprises:
a process for said innovative computer program and software and stored procedures to cause said processor units and memories to repetitively analyze, scan and match said submissions with individual SQL units in said processor units and memories for said processor units and memories to generate and display related individual outcomes comprise information and data on diagnosis, individual diagnoses, individual syndromes, individual groups of diagnoses and/or syndromes and related said information and data on health, health-care services and diseases, disorders and illnesses and related information and data on individual physicians and/or individual groups of physicians in adaptable interactive linked electronic templates, pop-up and drop-downs in said viewing screens; and
a process for said innovative computer program and software and stored procedures to cause said processor units and memories to repetitively analyze, scan and match said submissions with said individual SQL units and related individual SQL keys related to words, terms, phrases and sentences in and among individual appropriate SQL units in said processor units and memories for said processor units and memories to generate and display related individual outcomes comprise information and data on diagnosis, individual diagnoses, individual syndromes, individual groups of diagnoses and/or syndromes and related said information and data on health, health-care services and diseases, disorders and illnesses and related information and data on individual physicians and/or individual groups of physicians in adaptable interactive linked electronic templates, pop-up and drop-downs in said viewing screens.

16. The method according to claim 5 wherein said process for said networks transforming random or chaotic processes for encountering of, between and among people seeking information and data on health, health-care, diseases, disorders and illness and related health and health-care services and managements of diseases, illnesses and disorders and related information and data on physicians into computer-servers ordered, guided and/or efficient encounters of, between and among said people comprises:
said process for said innovative computer program and software and stored procedures to cause said processor units and memories to create and generate and display individual unique interactive patients' words, terms, phrases or sentences in the viewing screens;
a plurality of individual adaptable interactive linked electronic templates, pop-ups, drop-downs and individual body sites, parts, illustrations, figurines, graphics comprising said interactive relational patients' words, terms, phrases or sentences in English or other languages displayed based on said orders or ranks numerical degrees of said prevalence of uses or preponderance of uses of said individual words, terms, phrases and sentences related to said in said SQL tables in said SQL databases in said viewing screen;
individual panels for logging and displaying chosen said patients' words, terms, phrases or sentences in said viewing screens;
said process for said networks assisting the diagnosing, managing and controlling diseases, illnesses and disorders and related risks, developments, courses, recurrences, progressions and preventions by, for and among people using said devices and/or platforms in said networks;
said process for networking said people in said networks for relating individual diagnoses related to individual or individual groups of related diseases, disorders and illnesses and related health and health-care services and managements of said diseases, illnesses and disorders and related information and data by, between and among people in diverse settings, circumstances and locations; and
triage of individual patients to and among said physicians in and by said networks.

17. The method according to claim 5 wherein said process for said networks transforming random or chaotic processes for encountering of, between and among people seeking information and data on health, health-care, diseases, disorders and illness and related health and health-care services and managements of diseases, illnesses and disorders and related information and data on physicians into computer-servers comprises:
said process for said networks assisting the diagnosing, managing and controlling diseases, illnesses and disorders and related risks, developments, courses, recurrences, progressions and preventions by, for and among people using said devices and/or platforms in said networks;
said process for innovative computer programs and software and stored procedures and said processor units and memories to instantly influence adaptable clinical decisions and consequent actions related to said adaptable displays of said relations and compositions in and among said adaptable Plasmids and numbers of displayed Plasmids of said of individual physicians or individual groups of physicians by generating and displaying individual interactive panels displaying instant, adaptable and interactive information and data on diagnosis, individual diagnoses, individual syndromes, individual groups of diagnoses and/or syndromes and related said information and data on health, health-care services and diseases, disorders and illnesses and related information and data on individual physicians and/or individual groups of physicians in adaptable interactive linked electronic templates, pop-up and drop-downs in said viewing screens; and, consequently,
triage of individual patients to and among said physicians in and by said networks.

18. The method according to claim 5 wherein said process for said networks dispensing, disseminating and sharing said information and data on diagnoses, diseases and illnesses and efficient and optimal managements, preventions and controls of said diseases, illnesses and disorders and related health-care services and cares by, among and between said people comprises:
said process for said innovative computer program and software and stored procedures and said processor units and memories causing repetitive retrievals and displays in said viewing screens adaptable relations and compilations of said interactive said unique patients' words, terms, phrases or sentences related to word and term headers or headings, 2-dimensional and 3-dimensional representations of body parts, illustrations, figurines, graphics, highlights, contrasts, macroscopic anatomy, microscopic anatomy, individual body sites, organ systems, DNA and RNA and/or biological and disease processes and events;
said process for said networks transforming random or chaotic processes for encountering of, between and among people seeking information and data on health, health-care, diseases, disorders and illness and related health and health-care services and managements of diseases, illnesses and disorders and related information and data on physicians into computer-servers ordered, guided and/or efficient encounters of, between and among said people;
said process for said innovative computer program and software and stored procedures to cause said processor units and memories to repetitively analyze, scan and relate individual SQL keys in and among said SQL tables in said SQL databases to create and generate relations and compilations of related SQL keys in and among said individual SQL units on related diseases, illnesses and disorders related to information and data on diagnoses and said people in and among said SQL tables in said SQL databases; and, consequently,
a process for computer server repetitively, automatically and instantly communicating, disseminating, sharing and/or technologically pushing, pulling, sharing and/or streaming said information and data related to said outcomes in said networks for instant or timed interactions by and among said people for diagnosing, managing and coordinating treatments, cares, contraindications and indications of treatments, surgeries and medications and drugs, of diseases, illnesses and disorders, warnings, preventions and controls of, monitoring and tracking diseases, disorders and illnesses and related epidemiologies, risks, developments, courses, recurrences, progressions for, by and among said people in diverse and different settings, circumstances and locations;
a process for computer servers automatically and vigilantly monitoring for and detecting aberrations generated by said people from information and data in said SQL relations in and among said SQL tables and instant warnings can be generated from aberrations from supra when clusters of information and data generated by and among patients and physicians deviate or different from information and data and push to said devices and platforms for and among people; and
a search function in said viewing screens.

19. The process for computer servers automatically and vigilantly monitoring for and detecting aberrations generated by said people from information and data in said SQL relations in and among said SQL tables and instant warnings can be generated from aberrations from supra when clusters of information and data generated by and among patients and physicians deviate or different from information and data and push to said devices and platforms for and among people according to claim 18 comprises:
a process for said innovative computer program and software and stored procedures to cause said processor units and memories to create and generate and display individual unique interactive patients' words, terms, phrases or sentences in the viewing screens;
a process for said networks assisting the diagnosing, managing and controlling diseases, illnesses and disorders and related risks, developments, courses, recurrences, progressions and preventions by, for and among people using said devices and/or platforms in said networks;
a process for said innovative computer program and software and stored procedures and said processor units and memories to repetitively create, generate and display a plurality of interactive related electronic Plasmids in said viewing screens of said devices and/or platforms being used by said people in said networks; and
a process for networking said people in said networks for relating individual diagnoses related to individual or individual groups of related diseases, disorders and illnesses and related health and health-care services and managements of said diseases, illnesses and disorders and related information and data by, between and among people in diverse settings, circumstances and locations.

20. In the networks of patients and physicians and computer servers, teleconferencing platforms including video conferencing henceforth platforms and computers, laptops, hand-held and mobile communication devices and equipment for accessing and interacting with said servers and platforms henceforth devices being used by patients and physicians using said devices and/or platforms for networking to and accessing said computer servers comprising relational information and data on health and health-care, including laboratory-generated laboratory data, related to, created and generated and submitted by said people to the processor units and memories of said computer servers and compiled and related as said relational information and data in and among SQL tables in SQL databases in and manage by a SQL server in said computer servers wherein said adaptable relational information and data are displayed on the viewing screens and interactive with, among and between and according to individual physicians, individual patients, individual groups of physicians and individual groups of physicians and patients in diverse and different settings, circumstances and locations henceforth people for computer servers-guiding and assisting in diagnosing, managing, treating, preventing and controlling diseases, illnesses and disorders and related developments, courses, risks, recurrences, progressions and preventions for, by, among and between said people using said networks, a method for instant or timed interactions by, among and between patients and physicians for diagnosing, managing and coordinating treatments, cares, preventions and controls of diseases, disorders and illnesses for, by and among patients and physicians by instantly and continually communicating, disseminating, sharing, said information and data on diagnoses, diseases and illnesses and managements and preventions said diseases, illnesses and disorders for, among and between patients and physicians in said networks of said computer servers, devices and platforms comprises:
a process for operating said networks comprising said functioning and operating computer servers, devices and platforms being used by and among said people;
a process for the innovative computer programs and software and stored procedures to instruct, command and cause said processor units and memories to repetitively and continually transform random or chaotic events for encountering of, between and among said people seeking information and data on health, health-care, diseases, disorders and illness and related health and health-care services and managements of diseases, illnesses and disorders into ordered, guided and/or efficient encounters and efficient and optimal managements of said diseases, illnesses and disorders, and dispensations and disseminations of said information and data and services of, for, between and among people in diverse and different settings, circumstances and locations and for instantly and continually communicating, disseminating and/or technologically pushing, pulling, streaming and sharing said relational information and data on diagnoses, diseases and illnesses and managing and preventing said diseases, illnesses and disorders for, among and between people in said networks;
a process for implementing said innovative computer program and software and stored procedures for creating and generating relations and compilations of words, terms, phrases, sentences, 2-dimensional and 3-dimensional representations of body parts, illustrations, figurines, graphics and related word and term headers or headings representing and related to categories of diagnoses and/or syndromes, differential diagnoses and related chief complaints, signs and symptoms and related PQRST, reviews of systems and related PQRST, physical examinations or findings, laboratory results and data, anatomical locations, anatomical sites and organ systems, diagnoses, syndromes, genetics, etiologies, causes, sources and pathologic basis of diseases and illnesses, family histories, travel histories, treatments, surgeries, procedures, assessments and plans, medications, recommendations, advices, referrals and follow-ups and related adjectives and variables and synonyms, acronyms and graphics and related qualifying information and data use by physicians of about 85 medical and surgical specialties and practices in computer files by physicians using said devices and/or platforms and submitting said relations and compilations to said processor units and memories from which said relations and compilations are computer server-automatically outputted and related by individual unique SQL keys and compiled, according to said innovative computer programs and software and stored procedures, in and among said SQL tables in said SQL databases;
a process for said innovative computer program and software and stored procedures to cause said processor units and memories to create and generate individual unique SQL units in and among said SQL tables in said SQL databases by said processor units and memories analyzing, checking, scanning and matching said relations and compilations of said words, terms, phrases, sentences, 2-dimensional and 3-dimensional representations of body parts, illustrations, figurines, graphics and related word and term headers or headings in and among SQL tables;
a process for said innovative computer program and software and stored procedures to cause said processor units and memories to analyze and relate individual SQL keys in and among said individual unique SQL units in and among said SQL tables in said SQL databases to create and generate relations and compilations of related SQL keys in and among said individual SQL units in and among SQL tables in said SQL databases;
a process for said innovative computer program and software and stored procedures to cause said processor units and memories to create and generate individual unique words, terms, phrases or sentences representing individual unique chief complaints, individual unique signs, individual unique symptoms and related individual unique PQRST, individual unique reviews of systems and related and individual unique PQRST, individual unique physical examinations or findings, individual unique laboratory results and data related to individual SQL keys which are related to individual unique SQL keys related to individual unique anatomical locations, macroscopic anatomy, microscopic anatomy, individual body sites, organ systems, DNA and RNA and biological and disease processes and events and individual unique keys related to individual diagnoses and individual syndromes in and among SQL tables in said SQL databases;
a process for said innovative computer program and software and stored procedures and said processor units and memories causing repetitive retrievals and displays in said viewing screens adaptable compilations of said interactive said unique words, terms, phrases or sentences related to individual interactive diagnoses or individual syndromes, individual groups of interactive diagnoses and/or individual groups of interactive diagnoses and/or interactive syndromes upon prompting by said devices and/or platforms being used by said people;
a process for said innovative computer program and software and stored procedures and to cause said processor units and memories to relate and compile relations and compilations of interactive said unique words, terms, phrases or sentences related to individual interactive diagnoses or individual syndromes, individual groups of interactive diagnoses and/or individual groups of interactive diagnoses and/or interactive syndromes by and among and submitted to said processor units and memories by physicians;
a process for said innovative computer program and software and stored procedures to cause said processor units and memories to analyze, calculate and tally the frequencies, degrees, preponderance or prevalence in said SQL tables in said SQL databases of individual relations or associations of and among related said unique words, terms, phrases or sentences related to individual unique anatomical locations, macroscopic anatomy, microscopic anatomy, individual body sites, organ systems, DNA and RNA and biological and disease processes and events in said relations and compilations created and generated by, among and/or between physicians using said devices and/or platforms and tabulated as numerical degrees of said relations or associations in said SQL tables in said SQL databases;
a process for said innovative computer program and software and stored procedures and said processor units and memories to repetitively create, generate and display a plurality of interactive related electronic Plasmids in said viewing screens of said devices and/or platforms being used by said people in said networks;
a process for said innovative computer program and software and stored procedures and said processor units and memories to repetitively create and generate a means for limiting accesses of said interactive electronic Plasmids among said people using said devices and/or platforms;
a process for said innovative computer program and software and stored procedures and said processor units and memories to repetitively retrieve and display said interactive said unique words, terms, phrases or sentences in orders or ranks based on said numerical degrees of said relations or associations of interactive said unique words, terms, phrases or sentences in and among said plurality of said related interactive electronic Plasmids comprising said related interactive said unique words, terms, phrases or sentences in said viewing screens and/or platforms;
a process for said innovative computer program and software and stored procedures to cause said processor units and memories to create and generate individual unique patients' words, terms, phrases or sentences representing individual unique chief complaints, individual unique signs, individual unique symptoms and related individual unique PQRST in English or other languages and 2-dimensional and 3-dimensional representations of body parts, illustrations, figurines, graphics and related word and term headers or headings;
a process for said innovative computer program and software and stored procedures and said processor units and memories causing repetitive retrievals and displays in said viewing screens adaptable compilations of said interactive said unique patients' words, terms, phrases or sentences and 2-dimensional and 3-dimensional representations of body sites, parts, illustrations, figurines, graphics and related word and term headers or headings related to individual diseases, illnesses or disorders upon prompting by said devices and/or platforms being used by said people;
a process for said innovative computer program and software and stored procedures to cause said processor units and memories to create and generate individual relations and compositions of unique patients' words, terms, phrases and/or sentences related to individual anatomical sites related to individual diagnoses and/or syndromes and related diseases, illnesses and disorders and related to individual unique SQL keys in and among SQL tables related to individual unique SQL keys related to said individual relations and compositions of said individual unique patients' words, terms, phrases and/or sentences and individual unique words, terms, phrases and/or sentences and related said numerical degrees and therefore related diagnoses and related information and data related to individual physicians related to individual unique SQL keys in and among SQL tables in said SQL databases in and manage by said SQL Server;
a process for said innovative computer program and software and stored procedures to cause said processor units and memories to create and generate and display individual unique interactive patients' words, terms, phrases or sentences in the viewing screens; and, consequently,
a process for said innovative computer program and software and stored procedures to cause said processor units and memories analyze, calculate and tally the frequencies, degrees, preponderance or prevalence of individual relations or associations of said patients' words, terms, phrases and sentences related to individual body sites, parts, illustrations, figurines, graphics in said patients' description of diseases, illnesses and disorders used by and among said patients using said devices and/or platforms and tabulated as numerical degrees of said prevalence of uses or preponderance of uses of said individual words, terms, phrases and sentences related to said individual body sites, parts, illustrations, figurines, graphics in said SQL tables in said SQL databases;
a process for said innovative computer program and software and stored procedures and said processor units and memories causing repetitive retrievals and displays in said viewing screens adaptable compilations of said interactive said unique patients' words, terms, phrases or sentences and 2-dimensional and 3-dimensional representations of body sites, parts, illustrations, figurines, graphics and related word and term headers or headings in orders or ranks numerical degrees of said prevalence of uses or preponderance of uses of said individual words, terms, phrases and sentences related to said individual body sites, parts, illustrations, figurines, graphics in said SQL tables in said SQL databases;
a process for said innovative computer program and software and stored procedures to cause said processor units and memories to create and generate relations and compilations of said patients' unique words, terms, phrases or sentences and related SQL keys and related said numerical degrees of said prevalence with corresponding or related individual unique words, terms, phrases or sentences representing individual unique chief complaints, individual unique signs, individual unique symptoms and related individual unique PQRST, individual unique reviews of systems and related and individual unique PQRST, individual unique physical examinations or findings, individual unique laboratory results and data related to individual SQL keys which are related to individual unique SQL keys related to individual unique anatomical locations, macroscopic anatomy, microscopic anatomy, individual body sites, organ systems, DNA and RNA and biological and disease processes and events and individual unique keys related to individual diagnoses and individual syndromes and related frequencies, degrees, preponderance or prevalence in said SQL tables in said SQL databases of individual relations or associations of and among related said unique words, terms, phrases or sentences in and among SQL tables in said SQL databases;
a process for said innovative computer program and software and stored procedures to repetitively cause said processor units and memories to automatically scan, analyze and match said words, terms, phrases or sentences created and generated and submitted to processor units and memories by said individual patients using said devices and/or platforms wherein said individual submissions are, first, automatically scan, analyze and match with unique words, terms, phrases or sentences and related SQL keys and related said numerical degrees of said prevalence and, consequently, second, based on said frequencies, degrees, preponderance or prevalence in said SQL tables in said SQL databases of individual relations or associations of and among related said unique words, terms, phrases or sentences, said related individual SQL keys related to individual unique words, terms, phrases or sentences representing individual unique chief complaints, individual unique signs, individual unique symptoms and related individual unique PQRST, individual unique reviews of systems and related and individual unique PQRST, individual unique physical examinations or findings, individual unique laboratory results and data related to individual SQL keys which are related to individual unique SQL keys related to individual unique keys related to individual diagnoses and individual syndromes and related information and data on physicians in and among SQL tables in said SQL databases and individual SQL Units;
a process for said networks assisting the diagnosing, managing and controlling diseases, illnesses and disorders and related risks, developments, courses, recurrences, progressions and preventions by, for and among people using said devices and/or platforms in said networks;
a process for innovative computer programs and software and stored procedures and said processor units and memories to instantly influence adaptable clinical decisions and consequent actions related to said adaptable displays of said relations and compositions in and among said adaptable Plasmids and numbers of displayed Plasmids of said of individual physicians or individual groups of physicians by generating and displaying individual interactive panels displaying instant, adaptable and interactive information and data on diagnosis, individual diagnoses, individual syndromes, individual groups of diagnoses and/or syndromes and related said information and data on health, health-care services and diseases, disorders and illnesses and related information and data on individual physicians and/or individual groups of physicians in adaptable interactive linked electronic templates, pop-up and drop-downs in said viewing screens;
a process for networking said people in said networks for relating individual diagnoses related to individual or individual groups of related and/or unrelated diseases, disorders and illnesses and related health and health-care services and managements of said diseases, illnesses and disorders and related information and data by, between and among people in diverse settings, circumstances and locations;
a process for said networks transforming random or chaotic processes for encountering of, between and among people seeking information and data on health, health-care, diseases, disorders and illness and related health and health-care services and managements of diseases, illnesses and disorders and related information and data on physicians into computer-servers ordered, guided and/or efficient encounters of, between and among said people; and
a process for said networks dispensing, disseminating and sharing said information and data on diagnoses, diseases and illnesses and efficient and optimal managements, preventions and controls of said diseases, illnesses and disorders and related health-care services and cares by, among and between said people.
